(19) United States
(12) Patent Application Publication
(10) Pub. No.: US 2025/0386162 A1
(43) Pub. Date: Dec. 18, 2025

(54) SPATIAL AUDIO PERSONALIZATION OF HEAD-RELATED TRANSFER FUNCTIONS USING MOBILE-TO-HEAD AUDIO RECORDINGS

(71) Applicant: QUALCOMM Incorporated, San Diego, CA (US)

(72) Inventors: Chun Kun KIM, Cambridge (GB); Ramji SRINIVASAN, Cambridge (GB); Andre SCHEVCIW, San Diego, CA (US)

(21) Appl. No.: 18/743,651

(22) Filed: Jun. 14, 2024

(51) Int. Cl. H04S 7/00

(52) U.S. Cl. CPC H04S 7/304; H04S 2420/01

(57) ABSTRACT

Systems and techniques are provided for processing audio data. For example, a process can include determining a set of near-field Head-Related Transfer Functions (HRTFs) corresponding to a user, based on a plurality of audio measurements each obtained using a respective measurement position at a near-field measurement distance. A set of far-field HRTFs corresponding to the user can be generated based on the set of near-field HRTFs. The set of far-field HRTFs can be compared to one or more candidate far-field HRTFs obtained based on anthropometric features corresponding to the user. An individualized HRTF can be determined for the user as a candidate far-field HRTF of the one or more candidate far-field HRTFs having minimum spectral differences from the set of far-field HRTFs at corresponding measurement positions.

### FIELD

The present disclosure generally relates to audio signal processing. For example, aspects of the present disclosure relate to generating personalized Head-Related Transfer Functions (HRTFs) based on mobile-to-head audio measurements obtained for a user.

### BACKGROUND

Spatialized audio rendering systems output sounds that may enable user perception of a three-dimensional (3D) audio space. Spatial audio (also referred to as three-dimensional or 3D audio) can refer to a variety of sound playback technologies that make it possible for a listener to perceive sound all around themselves, without the need for a multiple speaker setup. For example, spatial audio technologies can cause a listener to perceive three-dimensional sound (e.g., spatial audio) based on emulating the acoustic interaction between real-world sound waves and the listener's ears. The interaction between sound waves and hearing anatomy, including the shape of the ears and the head, can be used to provide spatial audio to a listener. For example, one or more Head-Related Transfer Functions (HRTFs) or other spatial sound filters can be used to enable user perception of a 3D audio space.

For example, a user may be wearing headphones, an augmented reality (AR) head mounted display (HMD), or a virtual reality (VR) HMD, and movement (e.g., translational or rotational movement) of at least a portion of the user may cause a perceived direction or distance of a sound to change. For example, a user may navigate from a first position in a visual (e.g., virtualized) environment to a second position in the visual environment. At the first position, a stream is in front of the user in the visual environment, and at the second position, the stream is to the right of the user in the visual environment. As the user navigates from the first position to the second position, the sound output by the spatialized audio rendering system may change such that the user perceives sounds of the stream as coming from the user's right instead of coming from in front of the user. To render or provide a listener with an accurate and immersive spatial audio experience, a high-quality and accurate spatial audio recording is often needed. For example, spatial audio recordings can be captured using multiple microphones that allow spatial information to be captured along with raw audio data, or otherwise determined from the raw audio data. Spatial information can include a direction of arrival (DOA) of particular sounds, arrival time differences (ATD) of a given sound at different microphone locations, arrival level differences of a given sound at different microphone locations, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for processing audio data. According to at least one illustrative example, a method of processing audio data is provided, the method including: determining, based on a plurality of audio measurements associated with a near-field measurement distance, a set of near-field Head-Related Transfer Functions (HRTFs) corresponding to a user, wherein each audio measurement of the plurality of audio measurements is obtained using a respective measurement position; generating a set of far-field HRTFs corresponding to the user, wherein the set of far-field HRTFs is based on the set of near-field HRTFs; comparing the set of far-field HRTFs to one or more candidate far-field HRTFs, wherein the one or more candidate far-field HRTFs are obtained based on anthropometric features corresponding to the user; and determining an individualized HRTF for the user as a candidate far-field HRTF of the one or more candidate far-field HRTFs having minimum spectral differences from the set of far-field HRTFs at corresponding measurement positions.

In another illustrative example, an apparatus for processing audio data is provided. The apparatus includes one or more memories and one or more processors coupled to the one or more memories and configured to: determine, based on a plurality of audio measurements associated with a near-field measurement distance, a set of near-field Head-Related Transfer Functions (HRTFs) corresponding to a user, wherein each audio measurement of the plurality of audio measurements is obtained using a respective measurement position; generate a set of far-field HRTFs corresponding to the user, wherein the set of far-field HRTFs is based on the set of near-field HRTFs; compare the set of far-field HRTFs to one or more candidate far-field HRTFs, wherein the one or more candidate far-field HRTFs are obtained based on anthropometric features corresponding to the user; and determine an individualized HRTF for the user as a candidate far-field HRTF of the one or more candidate far-field HRTFs having minimum spectral differences from the set of far-field HRTFs at corresponding measurement positions.

In another example, a non-transitory computer-readable medium is provided that includes instructions that, when executed by one or more processors, cause the one or more processors to: determine, based on a plurality of audio measurements associated with a near-field measurement distance, a set of near-field Head-Related Transfer Functions (HRTFs) corresponding to a user, wherein each audio measurement of the plurality of audio measurements is obtained using a respective measurement position; generate a set of far-field HRTFs corresponding to the user, wherein the set of far-field HRTFs is based on the set of near-field HRTFs; compare the set of far-field HRTFs to one or more candidate far-field HRTFs, wherein the one or more candidate far-field HRTFs are obtained based on anthropometric features corresponding to the user; and determine an individualized HRTF for the user as a candidate far-field HRTF of the one or more candidate far-field HRTFs having minimum spectral differences from the set of far-field HRTFs at corresponding measurement positions.

In another example, an apparatus for processing audio data is provided. The apparatus includes: means for determining, based on a plurality of audio measurements associated with a near-field measurement distance, a set of near-field Head-Related Transfer Functions (HRTFs) corresponding to a user, wherein each audio measurement of the plurality of audio measurements is obtained using a respective measurement position; means for generating a set of far-field HRTFs corresponding to the user, wherein the set of far-field HRTFs is based on the set of near-field HRTFs; means for comparing the set of far-field HRTFs to one or more candidate far-field HRTFs, wherein the one or more candidate far-field HRTFs are obtained based on anthropometric features corresponding to the user; and means for determining an individualized HRTF for the user as a candidate far-field HRTF of the one or more candidate far-field HRTFs having minimum spectral differences from the set of far-field HRTFs at corresponding measurement positions.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip examples or implementations, or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SOC), in accordance with some examples;

FIG. 2 is a diagram illustrating an example of a wearable audio device including a speaker and one or more microphones, in accordance with some examples;

FIG. 3A is a diagram illustrating an example of audio measurements performed between audio receivers included on ear-worn devices of a user and an audio transmitter device using a plurality of different locations, in accordance with some examples;

FIG. 3B is a diagram illustrating examples of locations of the audio transmitter device at different corresponding azimuth angles to ear-worn devices of a user, in accordance with some examples;

FIG. 3C is a diagram illustrating an example of locations of the audio transmitter device at different corresponding elevation angles to ear-worn devices of a user, in accordance with some examples;

FIG. 4 is a diagram illustrating an example of a system for generating a personalized Head-Related Transfer Function (HRTF) for a user, in accordance with some examples;

FIG. 5 is a flow chart illustrating an example of a process for processing audio data, in accordance with some examples; and

FIG. 6 is a block diagram illustrating an example of a computing system, in accordance with some examples.

### DETAILED DESCRIPTION

Certain aspects and aspects of this disclosure are provided below. Some of these aspects and aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides exemplary aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the scope of the application as set forth in the appended claims.

References to a “location” of a microphone of a multi-microphone audio sensing device can indicate the location of the center of an acoustically sensitive face of the microphone, unless otherwise indicated by the context. The term “channel” is used at times to indicate a signal path and at other times to indicate a signal carried by such a path, according to the particular context. Unless otherwise indicated, the term “series” is used to indicate a sequence of two or more items. The term “logarithm” is used to indicate the base-ten logarithm, although extensions of such an operation to other bases are within the scope of this disclosure. The term “frequency component” is used to indicate one among a set of frequencies or frequency bands of a signal, such as a sample of a frequency domain representation of the signal (e.g., as produced by a fast Fourier transform) or a subband of the signal (e.g., a Bark scale or Mel scale subband).

Spatialized audio can refer to the capture and reproduction of audio signals in a manner that preserves or simulates location information of audio sources in an audio scene (e.g., a 3D audio space). To illustrate, upon listening to playback of a spatial audio signal, a listener is able to perceive a relative location of various audio sources in the audio scene relative to each other and relative to the listener. One format for creating and playing back spatial audio signals is channel-based. In channel-based audio, loudspeaker feeds are adjusted to create a reproduction of the audio scene. Another format for spatial audio signals is object-based audio. In object-based audio, audio objects are used to create spatial audio signals. Each audio object is associated with 3D coordinates (and other metadata), and the audio objects are simulated at the playback side to create perception by a listener that a sound is originating from a particular location of an audio object. An audio scene may consist of several audio objects. Object-based audio is used in multiple systems, including video game systems. Higher order ambisonics (HOA) is another format for spatialized audio signals. HOA is used to capture, transmit and render spatial audio signals. HOA represents an entire sound field in a compact and accurate manner and aims to recreate the actual sound field of the capture location at the playback location (e.g., at an audio output device). HOA signals enable a listener to experience the same audio spatialization as the listener would experience at the actual scene. In each of the above formats (e.g., channel-based audio, object-based audio, and HOA based audio), multiple transducers (e.g., loudspeakers) are used for audio playback. If the audio playback output by headphones, additional processing (e.g., binauralization) is performed to generate audio signals that “trick” the listener's brain into thinking that the sound is arriving from different points in the space rather than from the transducers in the headphones.

Spatial audio (also referred to as “3D” audio) describes a variety of sound playback technologies that make it possible for a listener to perceive sound all around themselves, without the need for a multiple speaker setup. Unlike stereo and surround sound audio formats (e.g., such as 5.1 channels or 7.1 channels), which portray audio in two dimensions and are tied to a specific multiple speaker setup, spatial audio can be used to portray audio in three dimensions (e.g., may introduce a height dimension) without a multiple speaker setup dependency.

Spatial audio technologies can cause a listener to perceive three-dimensional sound (e.g., spatial audio) based on emulating the acoustic interaction between real-world sound waves and a user's ears. In particular, the interaction between sound and hearing anatomy, including the shape of the ears and the head, can be used to provide spatial audio to a listener. For example, binaural spatial audio delivery (e.g., using a standard headphone or headset with left and right ear outputs) can allow a listener to perceive an audio playback source as if it were an object placed at a particular 3-dimensional position and space, e.g., above or behind the head, etc. Use cases include video games, XR applications, and other scenarios where immersive audio is desired (e.g., where the presented auditory scene in combination with any visual cues help the user to have an immersive experience of being in, or present for, the scene).

Binaural delivery of spatial audio can be based on manipulating the auditory cues of a sound source located in 3D space, such as the differences in the intensity or the arrival time of the sound waves between the two ears, and the spectral characteristics of the signals at the two ears. These auditory cues vary based on the location of the sound source, and may be represented in the set of corresponding impulse responses captured at the ear anatomy of the particular listener. The impulse responses can be converted to transfer functions known as Head-Related Transfer Functions (HRTFs), which may be used to provide spatial audio playback.

An HRTF is a frequency-domain representation of an acoustic filter that describes how a sound from a specific point in space reaches the ear. A Head-Related Impulse Response (HRIR) is a time-domain representation of the same acoustic filter. An HRTF is specific to the particular ear and head anatomy for which the impulse responses were captured, as different ear and/or head anatomy can cause differences in the perception of various auditory cues that affect the delivery of spatial audio. For example, the interaural time difference (ITD) is the difference in arrival time of a sound between the left and right ears, and is used by the brain to determine the sound source's location in the horizontal plane. The interaural level difference (ILD) corresponds to the sound intensity difference between the left and right ears (e.g., caused by the head's “acoustic shadow”), and is used by the brain to determine cues for locating sounds in the vertical and front/back planes. HRTFs are typically measured in an anechoic chamber/laboratory setting, as the precision of the various measurements is important for the accuracy of the resulting HRTF. The typical procedure to obtain these HRTFs is to place a pair of microphones at the user's ears and to record the responses in a given space from a point source at all possible directions (depending on the target spatial resolution). Any sound object in the same space can be synthesized by filtering the original source signal with the pair of HRTFs corresponding to the intended direction.

In some examples, photographs of the subject's ears are also taken and stored together with the recorded ear signals. The recorded ear signals and resulting HRTF or HRIR provide direct acoustic measurements of how an ear receives a sound from a specific point in space, and photographs of the subject's ears can provide a visual representation of the unique ear and head anatomy that governs how the ear will receive sound from a specific point in space. In some techniques, a baseline or initial HRTF can be selected as an approximate match for a user, and the baseline HRTF is subsequently refined based on hearing anatomy features or characteristics identified from an analysis of the unique anatomy represented in photographs of the user's ears.

Challenges associated with HRTF acquisition can include the time and effort needed to capture signals at all possible directions around the listener, and that the resulting set of HRTFs produced from the collected signals are only accurate to the specific user for which the signal collection is performed. For example, an HRTF generated using collected signals obtained for a first user may be inaccurate and/or non-optimal if used to generate binaural or spatial audio for a second user, based on anthropometric differences between individuals' hearing anatomy, such as the pinna and head shapes.

In one approach to generalizing HRTFs to individuals beyond a specific user, a dummy head can be used with representative anthropometric dimensions for the HRTF collection, and the collected set can then be used as a generic database. However, the generic or average HRTF set may not be as perceptually convincing to listeners as compared to the listener's own HRTF set, when used to deliver binaural spatial audio. It remains challenging to collect an individual, complete HRTF set for every user, and many approaches use a database of human HRTFs and perform matching to select a closest match HRTF from the database for each individual listener.

Selection techniques for matching an individual listener to an existing HRTF within a human HRTF dataset can include direct selection of an HRTF set through listening and comparison, and indirect matching or selection of an HRTF set based on photographs of the listener's pinna (e.g., ear anatomy). There is a need for systems and techniques that can be used to generate, from existing human HRTF datasets, more accurately matching individualized HRTFs that are adapted to a particular user or listener.

Systems, apparatuses, processes (also referred to as methods), and computer-readable media (collectively referred to as “systems and techniques”) are described herein that can be used to perform enhanced personalization of HRTFs selected for a particular user from a dataset of a plurality of generic HRTFs (e.g., human HRTF samples). The selected HRTF may be utilized to deliver more perceptually convincing binaural spatial audio through the speaker units of headphones or earbuds worn by the particular user. The systems and techniques can be used to reinforce indirect HRTF matching techniques, such as vision-based anthropometric matching.

In some examples, the systems and techniques can be used to generate personalized HRTFs for users, based on obtaining information corresponding to a plurality of mobile-to-ear audio measurements obtained between a handheld device and one or more ear-worn devices of the user. For example, the plurality of mobile-to-ear audio measurements can be obtained between a mobile phone or other handheld computing device of the user, and one or more headphones, earbuds, or other ear-worn devices worn in the user's ears. The user can position the mobile device in a plurality of different positions relative to the ear-worn devices, and one or more mobile-to-ear audio measurements can be performed for each position by playing a tone or signal from the handheld device and measuring the received audio at each of the ear-worn devices. Based on the ear-worn devices or earbuds being placed within the user's ears, the relative orientation between the ear-worn devices and the handheld device may be the same as or similar to the relative orientation between the user's head or face and the handheld device.

In some cases, the handheld device can capture and analyze image data to determine the relative position or orientation between the user's face or head, and the handheld device, which can subsequently be used to determine the relative position or orientation between the ear-worn devices and the handheld device associated with the mobile-to-ear audio measurement(s). In some examples, the handheld device can use one or more radio frequency (RF) sensing or positioning techniques to determine the relative position and/or orientation information between the handheld device and the user's head or face. In some cases, the handheld device can use RF sensing or positioning techniques to determine the relative position or orientation information between the handled device and the ear-worn devices (e.g., the ear-worn devices worn by the user and configured to capture or measure the tones or signals played by the handheld device at each measurement position of the plurality of measurement positions corresponding to the mobile-to-ear audio measurements).

The mobile-to-ear audio measurements can be used to determine one or more HRTFs for the user. For example, based on obtaining a plurality of measurements of a sweep signal or other configured tone, a subset of the user's individualized HRTFs can be determined. In some cases, the subset of the user's HRTFs can be calculated based on relative position or orientation information associated with each respective measurement obtained by the ear-worn devices (e.g., measured or received audio data recorded by a microphone on each ear-worn device, and corresponding to the sweep signal played by the handheld device). For example, the relative position or orientation information can be used to localize the sound source of the audio measurement (e.g., the handheld device or speaker thereof) of an ear-worn device in the user's right ear, and can be used to localize the sound source of the audio measurement of an ear-worn device in the user's left ear.

In some examples, the plurality of mobile-to-ear audio measurements obtained at the plurality of discrete positions of the handheld device around the user (e.g., different azimuth angle and elevation angle combinations, etc.) can be used to determine a subset of the user's individualized HRTFs. In some cases, the subset of the user's individualized HRTFs may be an approximation of the user's ground truth or underlying HRTFs (e.g., which are typically measured or estimated in a laboratory setting, using an anechoic chamber, and/or using thousands of discrete measurements and/or measurement points, etc.). The subset of the user's HRTF information can correspond to the subset of (azimuth angle, elevation angle) combinations represented within the plurality of discrete positions used to obtain the mobile-to-ear audio measurements. For example, mobile-to-ear audio measurements obtained at (azimuth 1, elevation 1, distance 1) and at (azimuth 2, elevation 2, distance 2), . . . , etc., between the user's head or ear-worn devices and the user's handheld device can correspond to (e.g., can be used to determine) a subset of the user's HRTF at the same discrete positions. For example, the subset can comprise the user's HRTF at (azimuth 1, elevation 1, distance 1) and at (azimuth 2, elevation 2, distance 2), . . . , etc.

In some cases, the subset of the user's HRTFs estimated based on the audio measurements performed between the user's handheld device and the ear-worn devices can correspond to near-field HRTFs. Near-field HRTFs can correspond to HRTFs that are measured over distances less than or equal to approximately one meter. HRTFs measured over distances that are greater than approximately one meter can be referred to as far-field HRTFs, and may have different properties and acoustic or analytical behaviors than near-field HRTFs. In some examples, the systems and techniques can use a far-field HRTF extrapolation engine to perform extrapolation of the user's subset of near-field HRTFs to a configured far-field HRTF distance. The configured far-field HRTF distance can correspond to the far-field HRTF distance associated with a database of reference human HRTFs, which may be obtained in a laboratory setting, using an anechoic chamber, etc.

The far-field HRTF extrapolation engine can be used to analyze and adjust distance-related characteristics of the user's subset of near-field HRTFs to the configured far-field HRTF distance of the reference database. Based on the extrapolation of the user's near-field HRTF subset to the far-field, the far-field HRTF extrapolation engine can be used to generate or derive the user's HRTF subset of far-field equivalent measurements.

The user's extrapolated far-field HRTF subset can be used to refine or reinforce a vision-based and/or anthropometry-based HRTF personalization technique. For example, a vision-based or anthropometry-based HRTF personalization technique can be performed to identify a plurality of candidate HRTF matches for the user, based on analyzing image data and/or three-dimensional (3D) scan data of the user's head, ears, or hearing anatomy. Anthropometry features can be determined or extracted based on the image data or scan data of the user's hearing anatomy, and feature-matching HRTF sets can be identified from a reference database as potential candidates for providing a personalized HRTF for the user.

The user's subset of extrapolated far-field HRTFs (e.g., determined by the far-field HRTF extrapolation engine, using the subset of near-field HRTFs determined from the plurality of mobile-to-ear audio measurements) can be analyzed and compared against the candidate HRTFs identified from the anthropometric feature matching. One or more features can be determined across the extrapolated far-field HRTFs and the candidate HRTFs for the same HRTF measurement position(s) and can be compared to identify or select a best matching candidate out of the plurality of candidate HRTFs. For example, the extrapolated far-field HRTFs determined for the user can be used to determine the best matching candidate HRTF as the candidate HRTF with minimum spectral differences from the user's extrapolated far-field HRTFs. The best matching candidate HRTF can be used as the personalized or individualized HRTF for the user.

Further aspects of the systems and techniques will be described with reference to the figures.

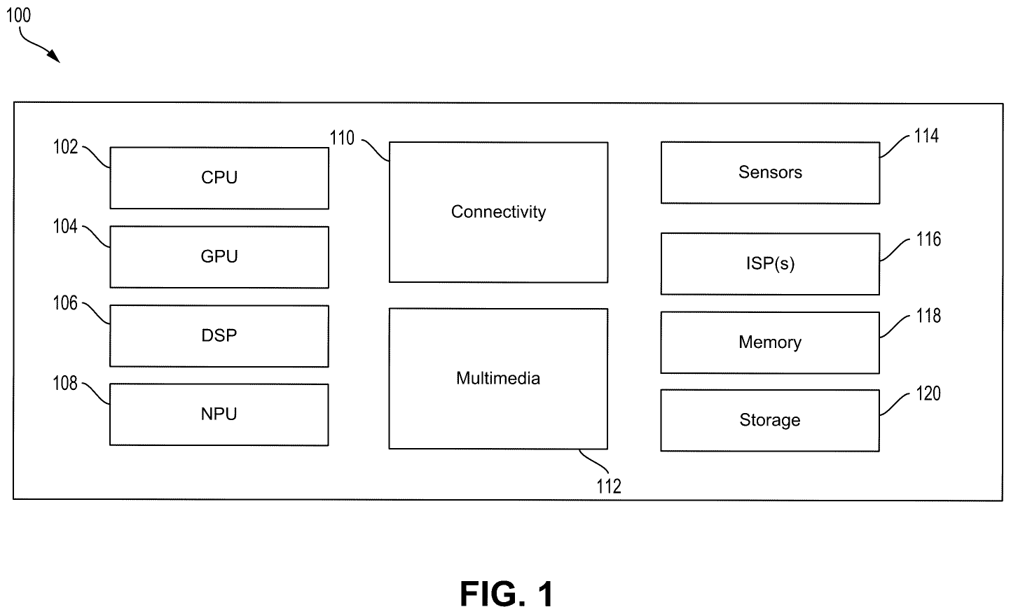

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include a sensor processor 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

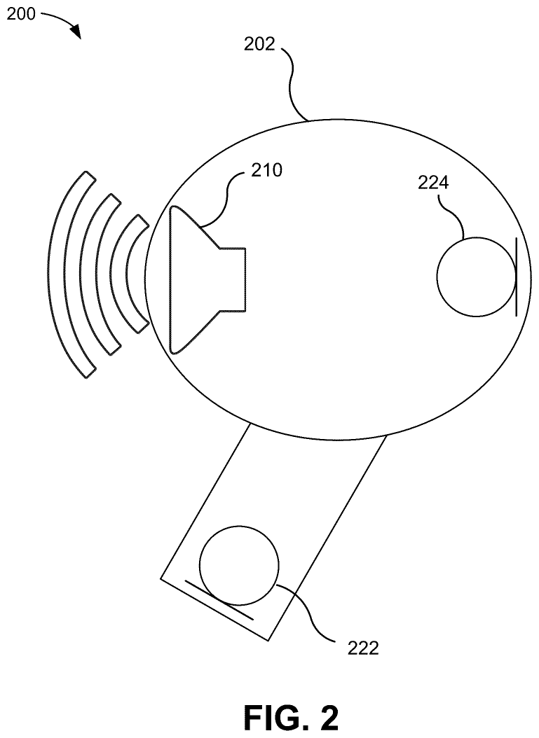

FIG. 2 is a diagram illustrating an example of a wearable audio device 200 including a speaker and one or more microphones, in accordance with some examples. For example, the wearable audio device 200 can be a headset for voice communications, a true wireless stereo (TWS) earbud, a headphone, a wearable device, a hearable device, etc. In some aspects, wearable audio device 200 can include or implement one or more of the components of FIG. 1.

The wearable audio device 200 can include at least one speaker 210 (e.g., among various other audio output devices, transducers, components, etc.) configured to output an audio signal to a user of the wearable audio device 200. In some examples, the speaker 210 can be used to provide playback or output of a binaural audio signal to the user of the wearable audio device 200. The wearable audio device 200 can include one or more microphones. In some examples, the wearable audio device 200 can include a plurality of microphones that are each configured to generate or obtain a respective microphone signal (e.g., respective audio data). In some examples, the wearable audio device 200 can include a first microphone 222 and a second microphone 224. In some examples, the first microphone 222 and the second microphone 224 may both be outward-facing microphones (e.g., outward-facing relative to a housing 202 of the wearable audio device 200). The first microphone 222 and the second microphone 224 may be examples of acoustic microphones, and may be the same as or similar to one another. In some aspects, the first microphone 222 and the second microphone 224 can be outward-facing acoustic microphones provided on or within the housing 202 of the wearable audio device 200.

In some examples, the first microphone 222 can be an outward-facing, acoustic microphone configured to perform audio pickup for the wearable audio device 200, and the second microphone 224 can be an outward-facing feedforward microphone. For example, the first microphone 222 may be utilized as a primary outward-facing microphone, and the second microphone 224 may be a feedforward acoustic microphone used for and/or associated with active noise cancelling (ANC) implemented by the wearable audio device 200, etc.

As noted previously, an HRTF is a frequency-domain representation of an acoustic filter that characterizes or corresponds to how a sound from a specific point in space reaches the ear. For example, as sound reaches a human listener, the size and shape of the head, ears, ear canal, density of the head, size and shape of nasal and oral cavities, can interact with and transform the sound to affect how the sound is perceived, boosting some frequencies and attenuating others.

A Head-Related Impulse Response (HRIR) is a time-domain representation of the same acoustic filter (e.g., in some examples, an HRIR can be a time-domain representation of a frequency-domain HRTF). An HRTF can be specific to the particular ear and head anatomy for which the impulse responses were captured, as different ear and/or head anatomy can cause differences in the perception of various auditory cues that affect the delivery of spatial audio. For example, the interaural time difference (ITD) is the difference in arrival time of a sound between the left and right ears, and is used by the brain to determine the sound source's location in the horizontal plane. The interaural level difference (ILD) corresponds to the sound intensity difference between the left and right ears (e.g., caused by the head's “acoustic shadow”), and is used by the brain to determine cues for locating sounds in the vertical and front/back planes.

Full HRTF measurement can utilize thousands of measurements and/or discrete measurement locations to determine a high-accuracy HRTF. Full HRTF measurement is usually performed in an anechoic chamber and/or a laboratory setting, as the precision of the various measurements corresponds to the accuracy of the resulting HRTF. An example of a typical procedure to obtain these HRTFs is to place a pair of microphones at the user's ears and record the responses in a given space from a point source moved through a plurality of different positions. In some cases, HRTFs obtained in a laboratory setting may record the responses from a point source moved through a plurality of different positions that are configured or selected to cover or approximate all possible directions (depending on the target spatial resolution for the resulting HRTF). Any sound object in the same space can be synthesized by filtering the original source signal with the pair of HRTFs corresponding to the intended direction.

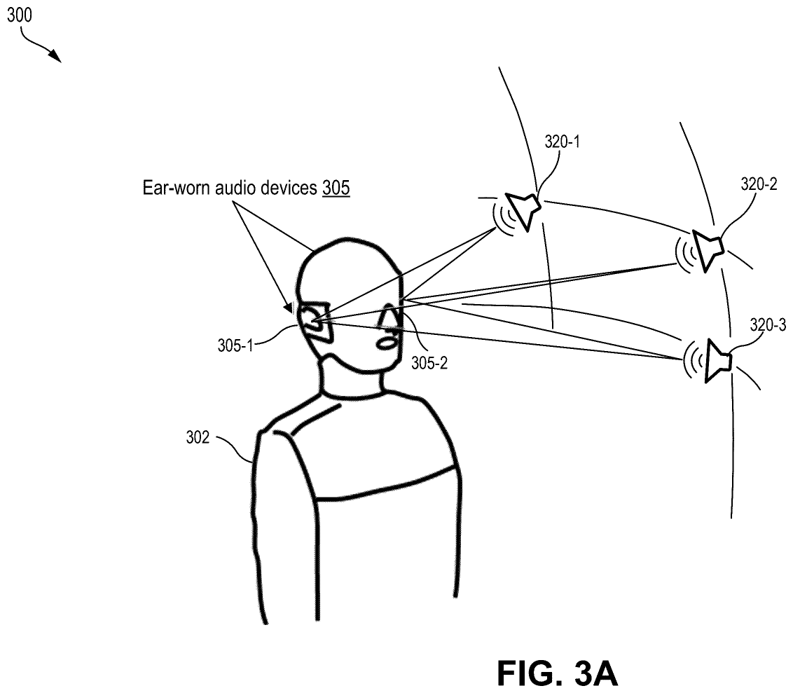

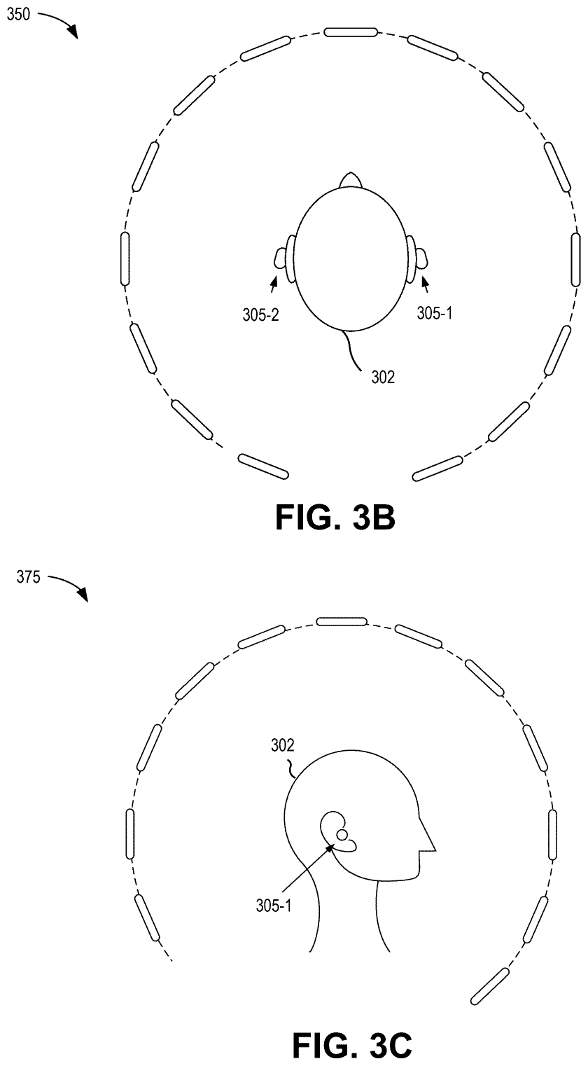

FIG. 3A is a diagram illustrating an example of audio measurements 300 performed between audio receivers included on ear-worn devices of a user and an audio transmitter device using a plurality of different locations, which may be utilized in determining or performing an HRTF measurement for a user 302. As noted previously, HRTF measurements may be performed using at least a pair of microphones placed at the ears of the user (e.g., the listener). In some cases, a single microphone is provided at each one of the left ear and the right ear. In some examples, multiple microphones can be provided at each ear. The user 302 of FIG. 3A can be associated with ear-worn audio devices 305, where each ear-worn audio device includes at least one microphone that can be used to obtain measurements or audio data corresponding to a point source audio signal. In one illustrative example, the ear-worn audio devices 305 can include at least a first ear-worn audio device 305-1 provided at a right ear of the user 302, and a second ear-worn audio device 305-2 provided at the left ear of the user 302. In some cases, each of the right and left ear-worn audio devices 305-1 and 305-2 (respectively) may be an example of an earbud, such as the earbud wearable audio device 200 of FIG. 2, etc.

Audio measurements for determining or estimating an HRTF can be performed based on using the microphones of the ear-worn devices 305 (e.g., e.g., 305-1, 305-2, . . . , etc.) to each record a respective response or audio data corresponding to an audio tone or audio signal that is played from a point source audio transmitter (e.g., a speaker) at a specific discrete position 320-1, 320-2, 320-3, . . . , etc., of a plurality of possible positions relative to the user 302 and/or the ear-worn audio devices 305.

At each discrete position 320-1, 320-2, 320-3, . . . , etc., the same audio tone or audio signal can be played from the speaker or other point source audio transmitter. The left ear-worn device 305-2 can be used to record or obtain a corresponding audio data or response for the signal traveling from location 320-1 to the left ear of the user 302. The right ear-worn device 305-1 can be used to record or obtain a corresponding audio data or response for the signal traveling from the location 320-1 to the right ear of the user 302. The same process can be performed at each of the remaining locations configured or utilized for the HRTF measurement (e.g., the second location 320-2, the third location 320-3, . . . , etc.).

Each location of the plurality of locations 320-1, 320-2, 320-3, . . . , etc., can be represented based on an azimuth angle between the user 302 and/or ear-worn devices 305, and the audio transmitter device. For example, FIG. 3B is a diagram illustrating examples of locations of the audio transmitter device at different corresponding azimuth angles to ear-worn devices 305-1 and 305-2 of the user 302, in accordance with some examples.

Each location of the plurality of locations 320-1, 320-2, 320-3, . . . , etc., can be further represented based on an elevation angle between the user 302 and/or ear-worn devices 305, and the audio transmitter device. For example, FIG. 3C is a diagram illustrating an example of locations of the audio transmitter device at different corresponding elevation angles to ear-worn devices 305-1 and 305-2 of the user 302, in accordance with some examples.

In some cases, each location of the plurality of locations 320-1, 320-2, 320-3, . . . , etc., can additionally be represented based on a distance between the user 302 and/or ear-worn devices 305 of the user, and the audio transmitter device.

In one illustrative example of an HRTF measurement process, a subject (e.g., user 302) may be equipped with a pair of in-ear microphones (e.g., ear-worn devices 305-1 and 305-2), and a sound source (e.g., a speaker or loudspeaker) is placed at a defined position (e.g., 320-1, 320-2, 320-3 of FIG. 3A; a selected azimuth angle of the plurality of azimuth angles shown in FIG. 3B; a selected elevation angle of the plurality of elevation angles shown in FIG. 3C; etc.) relative to the subject.

A known signal is played from the speaker, and the respective left and right ear responses are recorded at the in-ear microphones, to determine or derive impulse responses to be convolved with a mono signal audio source. Various techniques (e.g., including the type and use of signals to play, and the methods to deconvolve) may be used to measure acoustic impulse responses. One example is to use a sine sweep as the excitation signal played from the speaker at each discrete location 320-1, 320-2, 320-3, . . . , etc. A sine sweep can be a continuous signal with a frequency that continuously changes with time. HRTFs can then be derived using the excitation signal and the recorded signals, for example based on applying linear deconvolution in the frequency domain. Head-Related Impulse Responses (HRIRs) can also be obtained directly in the time domain by convolving the recorded signals with the time-inversed version of the excitation signal. The measurement can be repeated over all of the perceivable sound source directions, to thereby obtain a dataset uniquely corresponding to the particular subject for which the HRTFs are obtained.

As noted previously, systems and techniques are provided herein that can be used to obtain a personalized or individualized HRTF for a user, based on performing a plurality of audio measurements between a handheld device and ear-worn devices of the user to estimate HRTF information corresponding to the user. A plurality of candidate HRTFs can be determined from a database of reference human HRTFs, based on performing anthropometric matching using anthropometric feature information determined based on one or more images or scans of the user's head, ears, and/or hearing anatomy. The estimated HRTF information of the user (e.g., determined from the plurality of audio measurements between the user's handheld device and ear-worn devices) can be used as a selection criteria for identifying a best match personalized HRTF for the user, out of the plurality of anthropometric candidate HRTFs.

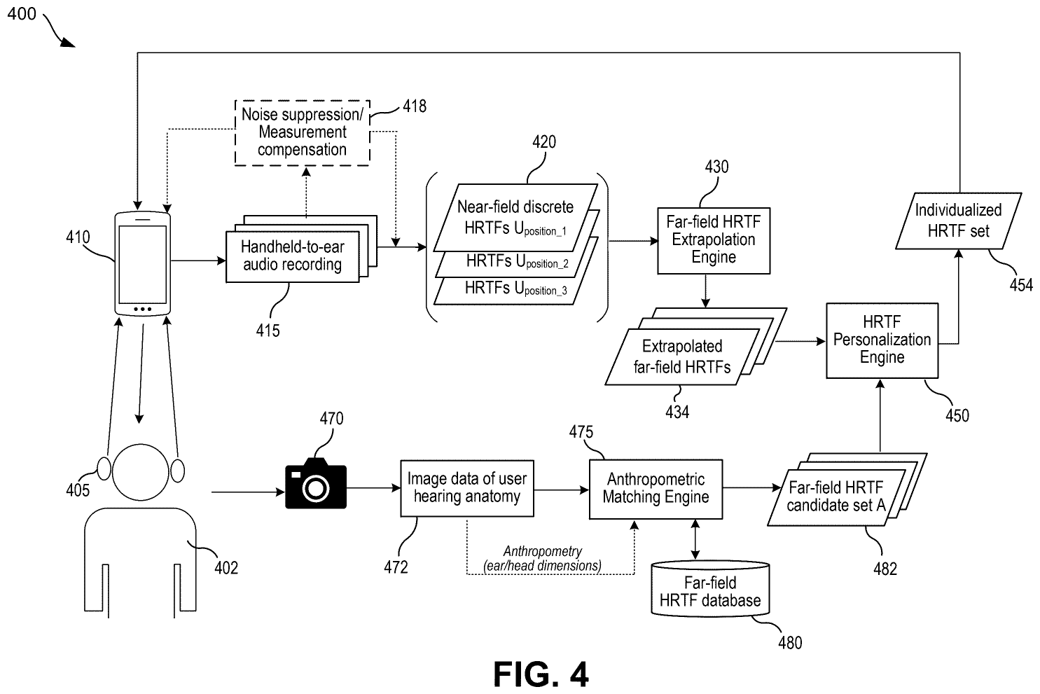

For example, FIG. 4 is a diagram illustrating an example of an audio processing system 400 that can be used to determine a personalized Head-Related Transfer Function (HRTF) for a user, in accordance with some examples. In one illustrative example, the audio processing system 400 can be used to determine the personalized HRTF for the user 402, where the personalized HRTF comprises and/or corresponds to the individualized HRTF set 454 generated as output by an HRTF personalization engine 450 of the audio processing system 400.

The user 402 may be associated with a pair of ear-worn devices 405 (e.g., a first ear-worn device 405 including at least one microphone positioned on or within the right ear of the user 402, and a second ear-worn device 405 including at least one microphone positioned on or within the left ear of the user 402). In some aspects, the ear-worn devices 405 of FIG. 4 can be the same as or similar to the ear-worn device 200 of FIG. 2, the ear-worn devices 305-1 and 305-2 of FIGS. 3A-3C, etc. In some examples, the pair of ear-worn devices 405 can be provided as a pair of true wireless stereo (TWS) earbuds, wired earbuds, on-ear or over-ear headphones, etc.

The ear-worn devices 405 can be associated with and/or perform wireless communications with a mobile computing device 410. For example, the mobile computing device 410 can be associated with the user, and may include one or more components of the system 100 of FIG. 1, etc. In some cases, the mobile computing device 410 can be a handheld computing device of the user (e.g., also referred to as a “handheld device”), such as a smartphone, a tablet, a smartwatch, a wearable device, etc.

The handheld device 410 can include one or more speakers that can be used to play a configured audio tone, signal, sound, etc., that can be used to obtain respective audio measurements from the pair of ear-worn devices 405 in the user's ears. For example, the handheld device 410 can include one or more speakers that can be configured as an audio source point signal to play a sweep signal from a plurality of discrete locations for determining one or more estimates of HRTF information corresponding to the user 402. In some aspects, the handheld device 410 can be configured to play a sweep signal or configured audio tone from a plurality of measurement locations that are the same as or similar to one or more of the measurement locations 310-1, 310-2, 310-3, . . . , etc., of FIG. 3A.

In some examples, the handheld device 410 can be used to play the sweep signal or configured audio tone from a plurality of different measurement locations around the user 402. For example, the user 402 can hold the handheld device 410 in their hand and the sweep signal can be played (e.g., output) by the speaker(s) of the handheld device 410 as the user 402 moves the handheld device 410 through a plurality of different measurement locations.

Each measurement location can correspond to a respective azimuth angle, elevation angle, and distance between the user 402 and the handheld device 410. In some aspects, the measurement locations can be represented using the respective azimuth, elevation, and distance between the handheld device 410 and the head or face of the user 402. In some examples, the measurement locations can be represented using the respective azimuth, elevation, and distance between the handheld device 410 and the pair of in-ear devices 405 worn in the left and right ears of the user 402.

In some examples, the handheld device 410 can be used to play a sweep signal or configured audio while the handheld device 410 is held in a fixed position relative to the user. The distance may correspond approximately to the length of the outstretched arm of the user 402 (e.g., based on the user holding the handheld device 410 in their hand during the process of obtaining the plurality of audio measurements from the plurality of different measurement locations between the device 410 and ear-worn devices 405). In some aspects, the user 402 can be prompted to move the handheld device 410 through at least a portion of the plurality of different azimuth angles within the 360-degree range of possible azimuth angles (e.g., such as the example device positions with different azimuth angles of FIG. 3B). In some cases, the user 402 may be prompted to move the handheld device 410 through at least a portion of the plurality of different elevation angles within the 360-degree range of possible elevation angles (e.g., such as the example device positions with different elevation angles of FIG. 3C, etc.).

In some cases, the different azimuth angles for positioning the handheld device 410 in the plurality of measurement positions can correspond to the clockwise and/or counterclockwise movements of the handheld device 410, from the perspective of the user 402. Different elevation angles for positioning the handheld device 410 in the plurality of measurement positions can correspond to the up and/or down movements of the handheld device 410, from the perspective of the user 402 (e.g., based on a horizontal coordinate system centered on the user 402, with azimuth and elevation used as the two independent horizontal angular coordinates).

In one illustrative example, the handheld device 410 and the pair of ear-worn devices 405 can be configured to perform a plurality of mobile-to-ear audio measurements (e.g., also referred to as handheld-to-ear audio measurements, or handheld-to-ear audio recordings) that can be used to obtain and/or determine HRTF information corresponding to the user 402. For example, the system 400 can use the handheld device 410 and ear-worn devices 405 to obtain coarse (e.g., quick, relatively low quality, etc.) binaural impulse responses that can be used to perform an initial estimation of individualized HRTF information for the user 402. In some aspects, the binaural impulse responses can be included or represented within the plurality of handheld-to-ear audio recordings 415, and/or may be determined or derived based on the plurality of handheld-to-ear audio recordings 415.

Each respective audio recording of the plurality of handheld-to-ear audio recordings 415 can correspond to a respective measurement position of the handheld device 410 relative to the user 402 and/or the user's ear-worn devices 405. For example, each respective audio recording of the plurality of handheld-to-ear audio recordings 415 can correspond to a discrete measurement position, such as the discrete measurement positions 320-1, 320-2, 320-3, . . . , etc., of FIG. 3A, etc.

The plurality of audio measurements 415 can be of sound played by the handheld device 410 (e.g., smartphone) and received or recorded by the ear-worn devices 405 (e.g., microphones on earbuds or headphones). The plurality of audio measurements 415 are obtained at a number of discrete positions around the user's head. At each discrete measurement position, the handheld device 410 can be configured to play a sweep signal that is captured by the microphones at the left and right ear (e.g., microphones on the ear-worn devices 405).

In some examples, the plurality of mobile-to-ear audio measurements 415 obtained at the plurality of discrete positions of the handheld device 410 around the user 402 (e.g., different azimuth angle and elevation angle combinations, etc.) can be used to determine a subset of the user's individualized HRTFs U. For example, based on the captured audio recordings 415 obtained for the sweep signal played at each measurement position, a subset 420 of the user's near-field HRTFs U can be determined. The subset 420 of the user 402 near-field HRTFs U can be near-field HRTFs based on the user 402 holding out the handheld device 410 at arm's length (e.g., a distance less than the approximate one meter boundary between the near-field and the far-field).

In some cases, the subset 420 of the user's individualized HRTFs U may be an approximation of the user's ground truth or underlying HRTFs (e.g., which are typically measured or estimated in a laboratory setting, using an anechoic chamber, and/or using thousands of discrete measurements and/or measurement points, etc.). The subset 420 of the user's HRTF information U can correspond to the subset of (azimuth angle, elevation angle) combinations represented out of the plurality of possible combinations of azimuth and elevation angle (e.g., possible discrete measurement positions) that can be used to obtain the mobile-to-ear audio measurements 415. For example, mobile-to-ear audio measurements obtained at (azimuth 1, elevation 1, distance 1) and at (azimuth 2, elevation 2, distance 2), . . . , etc., between the user's head or ear-worn devices 405 and the user's handheld device 410 can correspond to a subset 420 of the user's HRTFs U at the same discrete positions. For example, the subset 420 can comprise the user's HRTFs U at (azimuth_1, elevation_1, distance_1), (azimuth_2, elevation_2, distance_2), . . . , etc.

In one illustrative example, the handheld-to-ear audio recordings 415 can include a first recording 415 obtained at a position_1 corresponding to (azimuth_1, elevation_1, distance_1), a second recording 415 obtained at a position_2 corresponding to (azimuth_2, elevation_2, distance_2), and a third recording 415 obtained at a position_3 corresponding to (azimuth_3, elevation_3, distance_3), . . . , etc.

The subset 420 of near-field discrete HRTFs obtained for the user 402 can include a near-field HRTF U_{position_1} corresponding to the HRTF at (azimuth_1, elevation_1, distance_1), a near-field HRTF U_{position_2} corresponding to the HRTF at (azimuth_2, elevation_2, distance_2), a near-field HRTF U_{position_3} corresponding to the HRTF at (azimuth_3, elevation_3, distance_3), . . . , etc.

In some aspects, the position and orientation of the mobile device 410 as the sound source for obtaining the plurality of handheld-to-ear audio recordings 415 can be configured relative to the head of the user 402. For example, the device 410 can be moved through the plurality of discrete measurement positions based on using a screen or display of the device 410 to provide real-time feedback to the user 402 indicative of when to move the device 410 to a new relative measurement position, and/or real-time feedback indicative of whether the user 402 has successfully moved the device 410 into the next relative measurement position or needs to perform an adjustment before the next sweep signal can be played.

In some examples, the device 410 can display instructions, prompts, and/or real-time feedback, etc., associated with the user moving the device 410 through the plurality of discrete measurement positions using a graphical user interface (GUI) displayed to the user 402 on the screen or display of the handheld device 410. For example, in some aspects, a mobile phone app running on the handheld device 410 can use a GUI to guide the user 402 into each of the configured discrete measurement positions (e.g., prompting the user to pose as if capturing a selfie at x degree direction as shown in an image or visual representation of feedback provided on the GUI, etc.) and then playing and capturing audio signals from the mobile phone 410 to a pair of connected earbuds 405. In another example, the handheld device 410 can be configured to track the user's head orientation with respect to the handheld device 410 as sweep signals are played by the handheld device 410 and recorded by microphones of the ear-worn devices 405, and the collection process for the audio recordings 415 can terminate after a configured plurality of different measurement positions or a configured quantity of different discrete measurement positions have each been captured.

In some aspects, the relative position and/or orientation of the handheld device 410 to the user 402 and/or ear-worn devices 405 can be determined based on one or more wireless communications between the handheld device 410 and the ear-worn devices 405. For example, the handheld device 410 can include a camera configured to capture image data of the user 402, and can analyze the captured image data to determine one or more of an elevation angle, an azimuth angle, and/or a distance between the user 402 and the handheld device 410. In some examples, the handheld device 410 can utilize one or more sensors (e.g., accelerometers, gyroscopes, inertial sensors, inertial measurement units (IMUs), etc.) to determine an estimate of the current measurement position or orientation between the handheld device 410 and the user 402 (e.g., determine an estimate of the current azimuth, elevation, and/or distance from the handheld device 410 to the user 402, etc.).

In some cases, the relative position and/or orientation of the handheld device 410 to the user 402 and/or ear-worn devices 405 can be determined based on one or more radio frequency (RF) transmissions, receptions, or measurements obtained by the handheld device 410. For example, the handheld device 410 can implement various RF positioning techniques to determine the current measurement position information between the handheld device 410 and the user 402. In some aspects, the handheld device 410 can perform RF sensing and/or can determine RF signal strength and/or RF phase measurement information that can be used to estimate the current measurement position information between the handheld device 410 and the user 402.

In some aspects, the plurality of handheld-to-ear audio measurements 415 can be obtained in any environment where the user 402 is located. The environment may be unlikely to replicate or reproduce the acoustic conditions of a noise-free anechoic chamber (e.g., the laboratory setting in which individualized HRTFs are typically collected). In some aspects, the system 400 can be configured to apply one or more noise analysis and/or noise suppression techniques 418. The noise analysis and suppression techniques 418 can be performed during the recording, and/or can be applied to the handheld-to-ear audio recordings 415 to thereby generate noise suppressed or noise-compensated audio recordings. For example, the noise suppression techniques 418 can include one or more of SNR estimation, noise characterization, noise suppression, noise cancellation and/or active noise cancellation (ANC), echo cancellation, etc., among various others. In some aspects, the noise suppression techniques 418 can be performed by the user's handheld device 410, the user's ear-worn device(s) 405, or various combinations of the handheld device 410 and the ear-worn devices 405.

In some examples, the noise analysis and noise suppression techniques 418 can be applied directly to the recorded measurement signals 415 to suppress noise. In some examples, the noise analysis and noise suppression techniques 415 can be used to generate an output to the user 402 that is indicative of the acceptability or quality of the recorded signals. For example, a noisy environment warning or notification can be generated to indicate to the user that the most recently or currently obtained audio recordings 415 have relatively high levels of noise. In some examples, a low-quality recording warning or notification can be generated to indicate to the user 402 that the most recently or currently obtained audio recordings 415 have relatively high SNR, interference, artifacts, cracking or popping, hissing, and/or various other indicators of low quality audio, etc. In some aspects, the user 402 can be prompted (e.g., by a GUI provided on a screen or display of the handheld device 410, etc.) to re-record any measurement positions that are associated with a corresponding handheld-to-ear audio recording 415 that is below a configured threshold of quality or noise level (e.g., re-record with or without sending the warning notification to the user 402 first).

In some cases, the subset 420 of the user's HRTFs U that is estimated based on the audio measurements 415 performed between the user's handheld device 410 and the ear-worn devices 405 can correspond to near-field HRTFs. Near-field HRTFs can be HRTFs that are measured over distances less than or equal to approximately one meter. HRTFs measured over distances that are greater than approximately one meter can be referred to as far-field HRTFs, and may have different properties and acoustic or analytical behaviors than near-field HRTFs. In some examples, the audio processing system 400 can use a far-field HRTF extrapolation engine 430 to perform extrapolation of the subset 420 of near-field user HRTFs U to a corresponding subset of user HRTFs at a configured far-field HRTF distance. The configured far-field HRTF distance is larger than the near-field distance used to obtain the subset 420 of near-field discrete user HRTFs U. In one illustrative example, the configured far-field HRTF distance used by the far-field HRTF extrapolation engine 430 can correspond to a far-field HRTF distance associated with a far-field HRTF database 480 of reference human HRTFs, which may be obtained in a laboratory setting, using an anechoic chamber, etc.

The far-field HRTF extrapolation engine 430 can be used to analyze and adjust distance-related characteristics of the user subset 420 of near-field HRTFs to the configured far-field HRTF distance of the reference database 480. Based on the extrapolation of the user's near-field HRTF subset 420 to the far-field, the far-field HRTF extrapolation engine 430 can be used to generate or derive the user's HRTF subset 434 of far-field equivalent measurements.

In some aspects, the far-field HRTF extrapolation engine 430 can be configured based on the system 400 obtaining or determining one or more far-field distances associated with the far-field HRTF database 480 (e.g., the one or more far-field distances represented within and used to measure the respective far-field human HRTFs included in the far-field HRTF database 480). For example, the one or more far-field distances associated with the far-field HRTF database can also be referred to as “configured far-field distances” and/or “configured far-field matching distances”, based on the far-field HRTF extrapolation engine 430 being configured to use the near-field HRTFs to generate extrapolated far-field HRTFs at the same far-field distance as is utilized by the reference HRTFs stored within the far-field HRTF database 480. The far-field HRTF database 480 can be a remote cloud database that includes human HRTFs (e.g., also referred to as reference or candidate HRTFs for HRTF personalization processes, etc.) that are based on far-field measurements obtained using measurements of sweep signals over distances greater than ˜1 m in a laboratory and/or anechoic chamber setting. At shorter distances, including over the distances associated with the near-field HRTFs 420 determined for the user 402, HRTFs may have a greater variance with distance (e.g., may vary more for the same change in distance, compared to the variance over the same distance when in the far-field measurement distances greater than approximately 1 m). In some aspects, direct matching between the user's near-field HRTFs subset U 420 with the far-field HRTFs of the far-field HRTF database 480 may be inaccurate. The far-field HRTF extrapolation engine 430 can be used to generate or calculate the extrapolated far-field HRTFs based on the user's near-field discrete HRTF subset 420, to increase the accuracy of subsequent HRTF matching and/or HRTF personalization performed by the HRTF personalization engine 450.

For example, the user's near-field HRTF subset U 420 can be associated with a set of measurement distances for the set of configured, discrete measurement points utilized for the recordings of the sweep signals. In one illustrative example, the user's near-field HRTF subset U 420 may be associated with distance_1=20 cm, distance_2=40 cm, etc. The measurement distances used to determine the coarse estimate of the near-field HRTF subset U 420 may be different than the measurement distance(s) associated with the HRTFs of the reference far-field HRTF database 480. For example, the reference far-field HRTF database 480 may be measured at a distance of 1.5 m for each measurement in the laboratory setting, etc., and the far-field HRTF extrapolation engine 430 can extrapolate each respective near-field distance (e.g., configured far-field matching distance) represented within the user's near-field discrete HRTFs subset U 420 to the far-field distance of 1.5 m associated with the reference database.

In one illustrative example, the far-field HRTF extrapolation engine can be configured to analyze and alter (e.g., extrapolate) distance-related HRTF characteristics of the user's near-field HRTF subset U 420 to match and/or normalize the various measurement distances (e.g., 20 cm, 40 cm, etc.) used for the handheld-to-ear recordings 415 to the configured measurement distance utilized for the HRTFs within the database 480 (e.g., 1.5 m). The user's own extrapolated far-field HRTF subset 434 Uₑ is derived, and provided as output from the far-field HRTF extrapolation engine 430. In some aspects, the user's extrapolated far-field HRTF subset 434 Uₑ can be representationally equivalent to as if the plurality of handheld-to-ear audio measurements 415 were captured at the database 480 configured far-field measurement distance (e.g., 1.5 m) rather than the actual near-field measurement distances (e.g., 20 cm, 40 cm, etc.) that were used.

In some aspects, the variations in characteristics of HRTFs are generally assumed to be negligible when the sources are located farther than approximately 3 m. However, near-field HRTFs within about 1-1.5 m can depend significantly on the distance. In one illustrative example, the far-field HRTF extrapolation engine 430 can be used to extrapolate HRTFs to varying distances from a limited number of measurements at distances different from the extrapolation target distance.

For example, the extrapolation can be performed starting from the wave equation describing acoustic pressure at a position caused by a given sound source. If an array of speakers (or loudspeakers) surrounds a space to reproduce a given sound field, the sound field P(x) at target position x can be derived using a speaker driving function D and a transfer function G from the speaker to the target position x (i.e., superposition of the contribution from all the surrounding speakers):

$$P ( x , k ) = {\int }_{0}^{2 π} D ( {x}_{0} , k ) \cdot G ( x - {x}_{0} , k ) {r}_{0} d {θ}_{0} \qquad Eq . ( 1 )$$

Here, k represents a frequency term in Eq. (1). For example, in cylindrical coordinates, the acoustic pressure perturbation propagating in a homogeneous medium can be given as P(x, k), where k is the wavenumber given by k=2πf/c with f representing the frequency and c representing the sound speed. Each speaker can be associated with a corresponding D calculation, where x₀ represents the speaker position as a vector of r₀ and θ₀ (e.g., an initial radius value r₀ and an initial azimuth value θ₀ representing the initial speaker position x₀ in cylindrical coordinates). To synthesize the sound from a far-field acoustic source xₛ, the speaker driving function D can also be calculated relatively, with each D expressed as a function of the speaker position x₀ and the intended source position xₛ consisting of rₛ and θₛ (e.g., an radius value rₛ and an azimuth value θₛ representing the intended source position xₛ in cylindrical coordinates). In some aspects, the speaker driving function D will vary based on the source position to be synthesized:

$$D ( {x}_{0} , k ) = {\sum }_{m = - M}^{M} \frac{2 {h}_{m} ( k {r}_{s} ) {e}^{- i m {θ}_{s}}}{i π {h}_{m} ( k {r}_{0} )} {e}^{i m {θ}_{0}} \qquad Eq . ( 2 )$$

Here, hₘ represents the Hankel function with order m, and M is the highest non-zero order. If the synthesized source is in the near-field (e.g., less than ˜1 m), the expression for D can be modified as in Eq. (3):

$$D ( {x}_{0} , k ) = {\sum }_{m = - M}^{M} \frac{2 {w}_{m} ( k ) {h}_{m} ( k {r}_{s} ) {e}^{- i m {θ}_{s}}}{i π {h}_{m} ( k {r}_{0} )} {e}^{i m {θ}_{0}} \qquad Eq . ( 3 )$$

The term wₘ can be used to represent a form of Wiener filter configured to compensate for the near-field amplitude interference effect inside the speaker array. Eq. (3) and Eq. (2) are both provided as a function of x₀ and xₛ. The sound field P from the acoustic source at xₛ can then be expressed as a function of x and xₛ only, with substitution to eliminate the x₀-related terms to obtain a representation of the sound field P for the near-field only:

$${P}_{r e p} ( x , k ) = {\sum }_{m = - M}^{M} {w}_{m} ( k ) {h}_{m} ( k {r}_{s} ) {e}^{- i m {θ}_{s}} {j}_{m} ( k r ) {e}^{i m θ} \qquad Eq . ( 4 )$$

Here, jₘ represents the Bessel function of the first kind with order m. When P at x represents the sound field at the ear, G in Eq. (1) can be treated as equivalent to the HRTF measured at discrete x₀ values, H_{{L,R}}(x₀, k). Eq. (1) can then be re-written as:

$${P}_{\{ L , R \}} ( k ) = {\int }_{0}^{2 π} D ( {x}_{0} , k ) \cdot {H}_{\{ L R \}} ( {x}_{0} , k ) {r}_{0} d {θ}_{0} \qquad Eq . ( 5 )$$

When the sound field from a source at xₛ is synthesized (e.g., the extrapolated target HRTF from xₛ), the representation of D from Eq. (3) can be used and includes all information of xₛ. Because D is also dependent on the speaker position (e.g., the HRTF measurement position), Eq. (5) can be expressed in the discrete format if L speakers are used around the head for the original HRTF measurement, for example using a configuration with L≥2M+1 for accurate sound field reproduction:

$${H}_{\{ L R \}} ( {x}_{s} , k ) = {\sum }_{l = 1}^{L} D ( {x}_{l} , k ) \cdot {H}_{\{ L R \}} ( {x}_{l} , k ) \qquad Eq . ( 6 )$$

In Eq. (6), D can be represented with x₀ replaced by x₁. And the extrapolated HRTF for the near-field can be determined as:

$${H}_{\{ L R \}} ( {x}_{s} , k ) = {\sum }_{l = 1}^{L} {\sum }_{m = - M}^{M} \frac{2 {w}_{m} ( k ) {h}_{m} ( k {r}_{s} )}{i π {h}_{m} ( k {r}_{l} )} {e}^{i m ( {θ}_{l} - {θ}_{s} )} {H}_{\{ L R \}} ( {x}_{l} , k ) \qquad Eq . ( 7 )$$

In some aspects, the far-field HRTF extrapolation engine 430 can generate the extrapolated far-field HRTFs 434 using Eq. (7) for the original measured HRTF subset 420 of the user's discrete HRTFs U.

In some aspects, the audio processing system 400 can use the extrapolated subset of the user's far-field HRTFs 434 as a selection criteria to refine a candidate set of far-field HRTFs 482, where the far-field candidate HRTFs 482 are selected from the far-field HRTF database 480 based on anthropometric information determined from image data 472 of the user hearing anatomy.

For example, the user's extrapolated far-field HRTFs 434 can be used by the HRTF personalization engine 450 to determine the best-matching HRTF set 454 from the existing database of far-field reference HRTFs 480. In one illustrative example, the extrapolated subset of far-field HRTFs 434 for the user 402 can be analyzed and used by the HRTF personalization engine 450 to refine an initial estimate or candidate set of far-field HRTFs A, B, C, etc., (e.g., referred to as the far-field candidate set 482 and/or the anthropometric HRTF candidates 482) that are identified from the HRTF database 480 using one or more vision-based anthropometry techniques to identify anthropometric features from photos or scans 472 of the user's hearing anatomy (e.g., ear, pinna, head, etc.).

In some aspects, a camera or image capture device 470 can be used to obtain the image data 472 of the user hearing anatomy. For example, the camera 470 can be used to obtain images 472 of the left and right ears of the user 402. The camera 470 can be included in the handheld device 410 or can be separate from the handheld device 410. In some aspects, the image data 472 can be obtained asynchronously with the handheld-to-ear audio recordings 415. For example, the image data 472 can be captured before or after obtaining the plurality of handheld-to-ear audio recordings 415. In some cases, the image data 472 can be obtained before the system 400 is configured to measure the handheld-to-ear audio recording information 415, and the image data 472 can additionally be processed by the anthropometric matching engine 475 to identify the far-field anthropometric matching JHRTF candidates 482 from the far-field reference HRTF database 480 before the handheld-to-ear audio recording information 415 is measured.

In one illustrative example, photographs of the user's left and right ears (e.g., the image data of user hearing anatomy 472) can be analyzed and used to perform anthropometric vision (e.g., pinna shape)-based matching by the anthropometric matching engine 475, to thereby identify the candidate set of far-field HRTFs 482 A, B, C, etc., from the far-field HRTF database 480. For example, based on the user 402 capturing, obtaining, providing, etc., the photographs of the left and right ear pinna (e.g., the image data 472), the anthropometric matching engine 475 can be configured to generate the far-field HRTF candidate set 482 as the three to five far-field HRTFs included within the far-field reference HRTF database 480 and having a correspondence to similar pinna shapes (e.g., similar anthropometric features) as identified in the user hearing anatomy image data 472.

In one illustrative example, the HRTF personalization engine 450 can be configured to compare the far-field candidates HRTFs 482 from the anthropometric vision-based matching engine 475 to the user's own HRTF subset U, as previously extrapolated to the same far-field distance used by the far-field candidate HRTFs 482 (e.g., based on the far-field HRTF extrapolation engine 430 generating the extrapolated far-field HRTFs 434 from the user's near-field HRTF subset 420 and using the configured far-field matching distance of the far-field HRTF database 480 from which the far-field HRTF candidates 482 are obtained).

In some aspects, a configured set of features can be determined (e.g., by the HRTF personalization engine 450) for the user's extrapolated far-field HRTF subset 434, at each measurement position of the plurality of measurement positions used to obtain the near-field HRTF subset 420 and the extrapolated far-field HRTFs 434. For example, the features of the extrapolated far-field HRTF subset 434 used for comparison with the far-field candidate HRTFs 482 can include high-frequency characteristics, etc.

In one illustrative example, if the user's extrapolated far-field HRTF subset 434 utilizes measurement positions of (azimuth_1, elevation_1) and (azimuth_2, elevation_2), then a respective subset can be extracted from each HRTF candidate 482, at each of the measurement positions. For example, a respective candidate HRTF subset can be obtained from the candidate HRTF sets 482 A, B, C at the corresponding measurement positions of (azimuth_1, elevation_1) and (azimuth_2, elevation_2).

In some aspects, the user's far-field HRTF subset 434 can include the HRTFs U_{e, position_1} and U_{e, position_2}, corresponding to the extrapolated user HRTF information at the configured far-field matching distance (e.g., 1.5 m) and for the first and second measurement positions of (azimuth_1, elevation_1) and (azimuth_2, elevation_2). The HRTF personalization engine 450 can perform the comparison to refine the anthropometric vision-based candidate HRTFs 482 based on obtaining the corresponding HRTF subsets from each far-field candidate 482 (e.g., far-field HRTF candidate A, B, C). For example, the corresponding HRTFs at position_1 and position_2 can be obtained from the candidate HRTFs A as the candidate subset A_{position_1}, A_{position_2}. The corresponding HRTFs at position_1 and position_2 can be obtained from the candidate HRTFs B as the candidate subset B_{position_1}, B_{position_2}. The corresponding HRTFs at position_1 and position_2 can be obtained from the candidate HRTFs C as the candidate subset C_{position_1}, C_{position_2}.

The candidate far-field HRTFs 482 subsets obtained for each corresponding measurement position represented within the user's extrapolated far-field HRTFs 434 can be compared by the HRTF personalization engine 450 to identify a best matching candidate far-field HRTF 454 for the user.

For example, the HRTF personalization engine 450 can analyze and compare the user's subset 434 of extrapolated far-field HRTFs U_{e,position_1} and U_{e,position_2} to the respective subsets for far-field HRTF candidate 482 A (e.g., compare U_{e,position_1}, U_{e,position_2} with A_{position_1}, A_{position_2}), to the respective subsets for far-field HRTF candidate 482 B (e.g., compare U_{e,position_1}, U_{e,position_2} with B_{position_1}, B_{position_2}), and to the respective subsets for far-field HRTF candidate 482 C (e.g., compare U_{e,position_1}, U_{e,position_2} with C_{position_1}, C_{position_2}).

In some aspects, the best-matching candidate far-field HRTF can be identified as the candidate far-field HRTF 482 with minimum spectral difference(s) from the user's own extrapolated far-field HRTFs 434 (e.g., at a pre-defined or configured frequency region, for example). The best-matching candidate far-field HRTF identified from the plurality of far-field HRTF candidates 482 by the HRTF personalization engine 450 can be used as the personalized or individualized HRTF set 454 for the user 402. In some aspects, the individualized HRTF set 454 can be provided or indicated to the handheld device 410 of the user 402, where the individualized HRTF set 454 can be used to generate binaural, spatial, 3D, etc., audio for playback to the user 402 (e.g., including playback using handheld device 410 to wireless transmit audio data processed using the individualized HRTF set 454 to the user's ear-worn devices 405).

In some aspects, the matching process between the candidate far-field HRTFs 482 and the user's extrapolated far-field HRTFs 434 can be performed locally (e.g., on or by the handheld device 410 used to obtain the mobile audio-based measurements 415). For example, the HRTF personalization engine 450 can be implemented locally, on or by the handheld device 410. In some cases, the far-field HRTF extrapolation engine 430 and/or the anthropometric matching engine 475 can be implemented locally on the handheld device 410. In some examples, the HRTF personalization engine 450 can be implemented remotely, for example as a cloud-based HRTF personalization engine 450. In some aspects, one or more of the far-field HRTF extrapolation engine 430 and/or the anthropometric matching engine 475 can be implemented remotely, for example in a same or different cloud as the HRTF personalization engine 450.

In some examples, the far-field HRTF database 480 can be located in the cloud, and the user's near-field HRTF subsets 420 can be uploaded to the cloud (e.g., from the handheld device 410), where the far-field HRTF extrapolation engine 430 can be implemented and/or used to match the configured far-field measurement distances and generate the extrapolated far-field user HRTF subsets 434 before subsequently selecting the best candidate HRTF set 434 from the candidate far-field HRTFs 482. In another example, the distance extrapolation to generate the extrapolated far-field user HRTF subsets 434 can be performed locally on the handheld device 410, and uploaded or transmitted to the cloud (e.g., a remote HRTF personalization engine 450) for matching against the candidate far-field HRTFs 482.

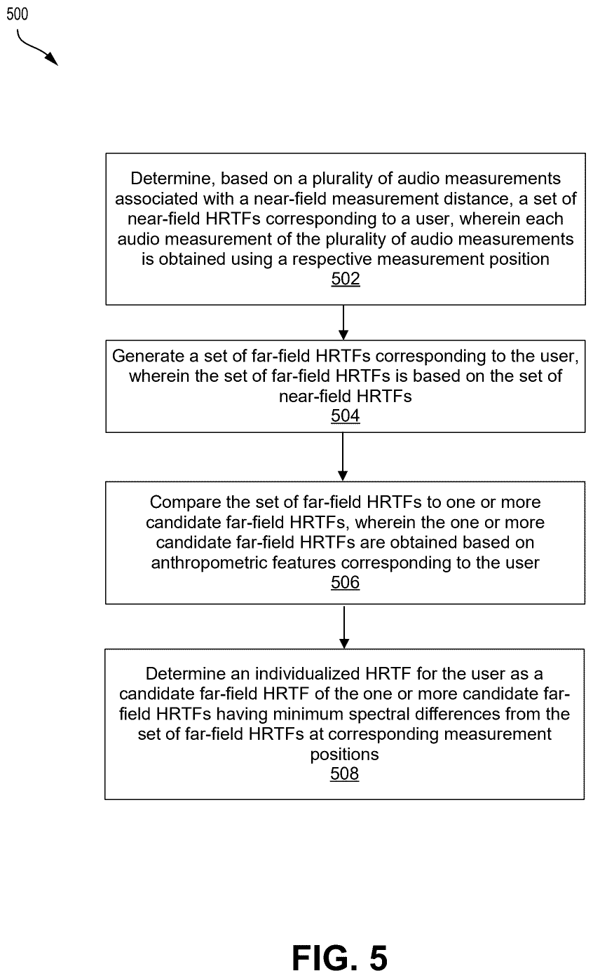

FIG. 5 is a flow chart illustrating an example of a process 500 for processing audio data. Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

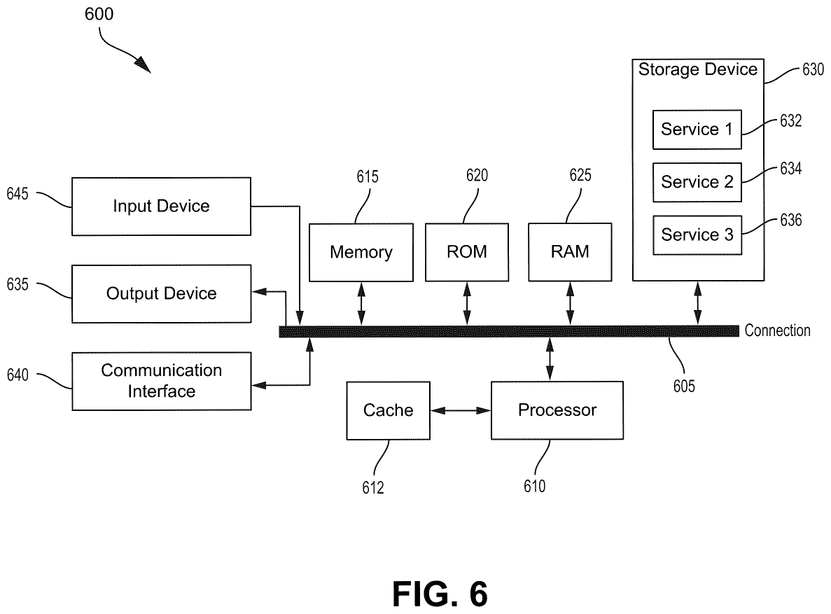

In some examples, the process 500 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 500 may be implemented as software components that are executed and run on one or more processors (e.g., processor 610 of FIG. 6 or other processor(s)). In some examples, the process 500 can be performed by a machine learning network, including any of the machine learning networks and/or neural networks. In some aspects, the process 500 can be performed by a UE, smartphone, mobile computing device, user computing device, etc. The process 500 may be performed by an apparatus that may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 500 may be implemented as software components that are executed and run on one or more processors (e.g., processor 610 of FIG. 6, and/or other processor(s)).

The process 500 can be performed by a computing device or apparatus. In one example, the processes described herein may be performed by a wireless communication device. In one example, the processes described herein may be performed by an audio device and/or wearable device that includes one or more microphones, etc. For instance, the audio device and/or wearable device can be the same as or similar to one or more of the devices of FIGS. 1-3C, one or more of the devices of the system 400 of FIG. 4, etc. In some examples, the process 500 can be performed by the system 400 of FIG. 4 (and/or one or more components thereof).

At block 502, the apparatus (or component thereof) can determine, based on a plurality of audio measurements associated with a near-field measurement distance, a set of near-field Head-Related Transfer Functions (HRTFs) corresponding to a user, wherein each audio measurement of the plurality of audio measurements is obtained using a respective measurement position.

For example, the plurality of audio measurements can be mobile-to-ear audio measurements, obtained using a mobile computing device (e.g., handheld device) associated with a user to output a configured signal or one, and using one or more ear-worn devices (e.g., earbuds, etc.) associated with the user to obtain an audio recording corresponding to the output of the configured signal from the handheld device. In some cases, the plurality of audio measurements are obtained using a handheld device associated with the user and a pair of ear-worn devices associated with the user. For example, the handheld device can include the SOC 100 of FIG. 1, and the pair of ear-worn devices can be the same as or similar to the ear-worn device 200 of FIG. 2. In some cases, the configured signal can be output by a speaker or audio transducer the same as or similar to the speakers 320-1, 320-2, 320-3 of FIG. 3A, and the pair of ear-worn devices can be the same as or similar to the pair of ear-worn devices 305-1 and 305-2 worn by the user 302 of FIG. 3A. In some examples, the pair of ear-worn devices can be the same as or similar to the ear-worn devices 305-1, 305-2 of FIGS. 3B and/or 3C. In some examples, the pair of ear-worn devices can be the same as or similar to the ear-worn devices 405 of FIG. 4.

In some cases, the set of near-field HRTFs includes a respective near-field HRTF corresponding to each measurement orientation of a plurality of measurement orientations. For example, the set of near-field HRTFs can be the same as or similar to the set of near-field discrete HRTFs 420 of FIG. 4, and can be based on the handheld-to-ear audio recordings 415 of FIG. 4.

In some cases, the respective measurement position associated with each audio measurement of the plurality of audio measurements is indicative of a relative position or orientation between the user and a handheld device associated with the user. For example, the respective measurement position can be indicative of a relative position or orientation between the user 402 and the handheld device 410 of FIG. 4.

In some examples, the respective measurement position associated with each audio measurement of the plurality of audio measurements is indicative of a relative position or orientation between a pair of ear-worn devices associated with the user and a handheld device associated with the user. For example, the respective measurement position can be indicative of the relative position or orientation between the pair of ear-worn devices 405 associated with the user 402 of FIG. 4, and the handheld device 410 associated with the user 402 of FIG. 4.

In some cases, each audio measurement of the plurality of audio measurements is a recording of an audio tone outputted from a speaker at the respective measurement position, and wherein the recording of the audio tone is obtained from a microphone included in an ear-worn device of the user. For example, the audio tone can be outputted from a speaker included in the handheld device 410 of FIG. 4, and can be recorded using a microphone included in the ear-worn device 405 of the user 402 of FIG. 4. In some cases, the near-field measurement distance corresponds to a distance between the ear-worn device of the user and the speaker at the respective measurement position. In some examples, the respective measurement positions can be the same as or similar to the measurement positions U_{position_1}, U_{position_2}, U_{position_3}, . . . , etc., of FIG. 4.

In some examples, the respective measurement position is indicative of an azimuth and an elevation between an audio source and a microphone, and each audio measurement of the plurality of audio measurements corresponds to an audio tone played by the audio source and recorded by the microphone. For example, the respective measurement position can be indicative of an azimuth and an elevation between an audio source comprising the handheld device 410 and a microphone included in the ear-worn device 405 of FIG. 4. In some examples, the azimuth and elevation positions can correspond to and/or can be similar to the different azimuth and elevation positions shown in FIGS. 3B and 3C.

In some examples, the set of near-field HRTFs is associated with a plurality of different near-field measurement distances associated with obtaining the plurality of audio measurements, and the configured far-field measurement distance is used for each extrapolated far-field HRTF of the plurality of extrapolated far-field HRTFs. In some cases, the configured far-field measurement distance can be associated with the far-field HRTF database 480 of FIG. 4. The plurality of extrapolated far-field HRTFs can be the same as or similar to the extrapolated far-field HRTFs 434 generated by the far-field HRTF extrapolation engine 430 of FIG. 4.

In some cases, to determine the set of near-field HRTFs corresponding to the user, the apparatus (or component thereof) can be configured to output, from a speaker included in a handheld computing device associated with the user, a sweep signal at each respective measurement position of a plurality of discrete measurement positions configured for the plurality of audio measurements. For example, to determine the set of near-field discrete HRTFs 420 corresponding to the user 402 of FIG. 4, a speaker included in the handheld computing device 410 associated with the user 402 of FIG. 4 can be configured to output the sweep signal at each respective measurement position of the plurality of discrete measurement positions U_{position_1}, U_{position_2}, U_{position_3}, . . . , etc., configured for the plurality of handheld-to-ear audio recordings 415 of FIG. 4 (e.g., the plurality of audio measurements).

The apparatus (or component thereof) can be configured to obtain, from a left ear-worn device and a right ear-worn device of the user, a corresponding mobile-to-ear audio measurement of the sweep signal at the respective measurement position. For example, the left ear-worn device and the right ear-worn device can be the same as or similar to the ear-worn device(s) 200 of FIG. 2, 304-1 and/or 305-2 of FIGS. 3A-3C, and/or 405 of FIG. 4, etc. In some cases, the near-field measurement distance comprises a distance between the handheld computing device and one or more of the left ear-worn device or the right ear-worn device of the user.

In some cases, the apparatus (or component thereof) can be configured to perform noise suppression or noise cancellation for the corresponding mobile-to-ear audio measurement, to thereby obtain an audio measurement of the plurality of audio measurements. For example, the noise suppression or noise cancellation can be the same as or similar to the noise suppression/measurement compensation 418 of FIG. 4, and can be performed for the plurality of handheld-to-ear audio recordings 415 of FIG. 4.

At block 504, the apparatus (or component thereof) can generate a set of far-field HRTFs corresponding to the user, wherein the set of far-field HRTFs is based on the set of near-field HRTFs. For example, the set of far-field HRTFs can be the same as or similar to the extrapolated far-field HRTFs 434 corresponding to the user 402 of FIG. 4, and can be generated using the far-field HRTF extrapolation engine 430 to process the set of near-Ofield HRTFs 420 of FIG. 4.

In some cases, the set of far-field HRTFs are generated to include a respective far-field HRTF corresponding to each measurement orientation of the plurality of measurement orientations. For example, the set of extrapolated far-field HRTFs 434 of FIG. 4 can include a respective extrapolated far-field HRTF for each measurement orientation of the plurality of measurement orientations U_{position_1}, U_{position_2}, U_{position_3}, . . . , etc., associated with the input set of near-field discrete HRTFs 420 of FIG. 4.

In some examples, to generate the set of far-field HRTFs, the apparatus (or component thereof) can be configured to extrapolate the set of near-field HRTFs from a near-field measurement distance of the respective measurement position to a configured far-field measurement distance, wherein the configured far-field measurement distance is greater than the near-field measurement distance. For example, the apparatus can use the far-field HRTF extrapolation engine 430 of FIG. 4 to extrapolate the set of near-field HRTFs 420 from a near-field measurement distance to a configured far-field measurement distance associated with the far-field HRTF database 480 of FIG. 4.

In some cases, the configured far-field measurement distance is associated with the one or more candidate far-field HRTFs. For example, the configured far-field measurement distance can be associated with the one or more candidate far-field HRTFs included in the set of far-field HRTF candidate sets 482 of FIG. 4. In some examples, the configured far-field measurement distance is associated with an HRTF database including a plurality of far-field HRTFs (e.g., the far-field HRTF database 480 of FIG. 4.). In some cases, the plurality of far-field HRTFs includes the one or more candidate far-field HRTFs. For example, the plurality of far-field HRTFs of the far-field HRTF database 480 can include the one or more candidate far-field HRTFs of the candidate set 482.

In some examples to generate the set of far-field HRTFs, the apparatus (or component thereof) is configured to determine one or more distance-based characteristics corresponding to the set of near-field HRTFs. For example, the one or more distance-based characteristics can correspond to the set of near-field discrete HRTFs 420. In some examples, the one or more distance-based characteristics corresponding to the set of near-field HRTFs 420 can be determined by the far-field HRTF extrapolation engine 430. In some examples, the far-field HRTF extrapolation engine 430 of FIG. 4 can be configured to extrapolate the one or more distance-based characteristics from a near-field measurement distance to a configured far-field measurement distance, to thereby generate a set of extrapolated far-field HRTFs corresponding to the user and the configured far-field measurement distance. For example, the far-field HRTF extrapolation engine 430 of FIG. 4 can extrapolate the one or more distance-based characteristics from the near-field measurement distance associated with each near-field discrete HRTF 420 to the configured far-field measurement distance associated with the far-field HRTF database 480 and the set of far-field HRTF candidates 482 of FIG. 4.

In some cases, the set of far-field HRTFs includes a plurality of extrapolated far-field HRTFs, and each extrapolated far-field HRTF of the plurality of extrapolated far-field HRTFs corresponds to a respective near-field HRTF included in the set of near-field HRTFs, and a configured far-field measurement distance greater than a near-field measurement distance associated with the respective near-field HRTF.

At block 506, the apparatus (or component thereof) can compare the set of far-field HRTFs to one or more candidate far-field HRTFs, wherein the one or more candidate far-field HRTFs are obtained based on anthropometric features corresponding to the user.

For example, the one or more candidate far-field HRTFs 482 can be obtained based on a comparison with anthropometric features corresponding to the user 402 and determined by the anthropometric matching engine 475 of FIG. 4. In some examples, the or more candidate far-field HRTFs are obtained as a selection from a plurality of reference far-field HRTFs, where the selection is performed based on anthropometric features corresponding to image data of ears of the user. For example, the anthropometric features can be determined by the anthropometric matching engine 475 of FIG. 4, based on the image data 472 obtained by the camera 470 and associated with the user 402 of FIG. 4. The anthropometric features can be determined by the anthropometric matching engine 475, and used to obtain the set of candidate far-field HRTFs 482 as a selection from the far-field HRTF database 480.

In some cases, to compare the set of far-field HRTFs to the one or more candidate far-field HRTFs, the apparatus (or component thereof) is configured to, for each measurement orientation of the plurality of measurement orientations, compare the respective far-field HRTF corresponding to the measurement orientation and a subset of the one or more candidate far-field HRTFs corresponding to the measurement orientation. For example, the comparison can be performed by the HRTF personalization engine 450, between the extrapolated far-field HRTFs 434 and the far-field HRTF candidate set(s) 482 of FIG. 4. In some cases, the set of far-field HRTFs is generated using a configured far-field matching distance associated with the one or more candidate far-field HRTFs. In some examples, the one or more candidate far-field HRTFs are selected from a plurality of far-field HRTFs based on the anthropometric features corresponding to the user.

In some cases, the one or more candidate far-field HRTFs are selected from a plurality of far-field HRTFs based on pinna-shape matching using image data of ears of the user. For example, the pinna-shape matching can be performed using the anthropometric matching engine 475 of FIG. 4, using the image data 472 of the user hearing anatomy. In some examples, the image data can be obtained using a camera of a handheld user computing device, such as the camera 470 and/or a camera included in the handheld device 410 associated with the user 402 of FIG. 4. In some cases, the plurality of audio measurements are obtained based on a plurality of audio tones outputted using a speaker of the handheld user computing device. In some examples, each candidate far-field HRTF of the one or more candidate far-field HRTFs comprises an HRTF subset corresponding to the plurality of measurement orientations and a configured far-field matching distance.

At block 508, the apparatus (or component thereof) can determine an individualized HRTF for the user as a candidate far-field HRTF of the one or more candidate far-field HRTFs having minimum spectral differences from the set of far-field HRTFs at corresponding measurement positions.

For example, the individualized HRTF can be the same as or similar to the individualized HRTF set 454 of FIG. 4, determined using the HRTF personalization engine 450 of FIG. 4. In some examples, the individualized HRTF set 454 can be determined based on using the HRTF personalization engine 450 to process the set of far-field HRTFs corresponding to the user (e.g., the extrapolated far-field HRTFs 434 of FIG. 4) as a selection criteria to refine the plurality of candidate far-field HRTFs associated with the anthropometric features of the user (e.g., the plurality of far-field HRTF candidate sets 482 of FIG. 4).

In some examples, the processes described herein (e.g., the process 500 and/or any other process described herein) may be performed by a computing device or apparatus. In some aspects, the process 500 and/or other technique or process described herein can be performed by a computing system having an architecture according to any of FIGS. 1-4. In another example, the process 500 and/or other technique or process described herein can be performed by the computing system 600 shown in FIG. 6. In some examples, the computing device can include a mobile device (e.g., a mobile phone, a tablet computing device, etc.), a wearable device, an extended reality device (e.g., a virtual reality (VR) device, an augmented reality (AR) device, or a mixed reality (MR) device), a personal computer, a laptop computer, a video server, a television, a vehicle (or a computing device of a vehicle), robotic device, and/or any other computing device with the resource capabilities to perform the processes described herein. In some cases, the computing device or apparatus may include various components, such as one or more input devices, one or more output devices, one or more processors, one or more microprocessors, one or more microcomputers, one or more transmitters, receivers or combined transmitter-receivers (e.g., referred to as transceivers), one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), neural processing units (NPUs), and/or other suitable electronic circuits), and/or can include and/or be implemented using computer software, firmware, or any combination thereof, to perform the various operations described herein.

The processes described herein may be illustrated or described as a logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes. Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 illustrates an example computing device architecture 600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 600 are shown in electrical communication with each other using connection 605, such as a bus. The example computing device architecture 600 includes a processing unit (CPU or processor) 610 and computing device connection 605 that couples various computing device components including computing device memory 615, such as read only memory (ROM) 620 and random access memory (RAM) 625, to processor 610.

Computing device architecture 600 can include a cache of high-speed memory connected directly with, in close proximity to, or integrated as part of processor 610. Computing device architecture 600 can copy data from memory 615 and/or the storage device 630 to cache 612 for quick access by processor 610. In this way, the cache can provide a performance boost that avoids processor 610 delays while waiting for data. These and other modules can control or be configured to control processor 610 to perform various actions. Other computing device memory 615 may be available for use as well. Memory 615 can include multiple different types of memory with different performance characteristics. Processor 610 can include any general purpose processor and a hardware or software service, such as service 1 632, service 2 634, and service 3 636 stored in storage device 630, configured to control processor 610 as well as a special-purpose processor where software instructions are incorporated into the processor design. Processor 610 may be a self-contained system, containing multiple cores or processors, a bus, memory controller, cache, etc. A multi-core processor may be symmetric or asymmetric.

To enable user interaction with the computing device architecture 600, input device 645 can represent any number of input mechanisms, such as a microphone for speech, a touch-sensitive screen for gesture or graphical input, keyboard, mouse, motion input, speech and so forth. Output device 635 can also be one or more of a number of output mechanisms known to those of skill in the art, such as a display, projector, television, speaker device, etc. In some instances, multimodal computing devices can enable a user to provide multiple types of input to communicate with computing device architecture 600. Communication interface 640 can generally govern and manage the user input and computing device output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof. Storage device 630 can include services 632, 634, 636 for controlling processor 610. Other hardware or software modules are contemplated. Storage device 630 can be connected to the computing device connection 605. In some aspects, a hardware module that performs a particular function can include the software component stored in a computer-readable medium in connection with the necessary hardware components, such as processor 610, connection 605, output device 635, and so forth, to carry out the function.

Aspects of the present disclosure are applicable to any suitable electronic device (such as security systems, smartphones, tablets, laptop computers, vehicles, drones, or other devices) including or coupled to one or more audio processing systems.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing audio data, comprising: one or more memories; and one or more processors coupled to the one or more memories, the one or more processors being configured to: determine, based on a plurality of audio measurements associated with a near-field measurement distance, a set of near-field Head-Related Transfer Functions (HRTFs) corresponding to a user, wherein each audio measurement of the plurality of audio measurements is obtained using a respective measurement position; generate a set of far-field HRTFs corresponding to the user, wherein the set of far-field HRTFs is based on the set of near-field HRTFs; compare the set of far-field HRTFs to one or more candidate far-field HRTFs, wherein the one or more candidate far-field HRTFs are obtained based on anthropometric features corresponding to the user; and determine an individualized HRTF for the user as a candidate far-field HRTF of the one or more candidate far-field HRTFs having minimum spectral differences from the set of far-field HRTFs at corresponding measurement positions.

Aspect 2. The apparatus of Aspect 1, wherein: the set of near-field HRTFs includes a respective near-field HRTF corresponding to each measurement orientation of a plurality of measurement orientations; and the set of far-field HRTFs are generated to include a respective far-field HRTF corresponding to each measurement orientation of the plurality of measurement orientations.

Aspect 3. The apparatus of Aspect 2, wherein each candidate far-field HRTF of the one or more candidate far-field HRTFs comprises an HRTF subset corresponding to the plurality of measurement orientations and a configured far-field matching distance.

Aspect 4. The apparatus of any of Aspects 2 to 3, wherein, to compare the set of far-field HRTFs to the one or more candidate far-field HRTFs, the one or more processors are configured to: for each measurement orientation of the plurality of measurement orientations, compare the respective far-field HRTF corresponding to the measurement orientation and a subset of the one or more candidate far-field HRTFs corresponding to the measurement orientation.

Aspect 5. The apparatus of any of Aspects 3 to 4, wherein the set of far-field HRTFs is generated using a configured far-field distance associated with the one or more candidate far-field HRTFs.

Aspect 6. The apparatus of any of Aspects 1 to 5, wherein the one or more candidate far-field HRTFs are selected from a plurality of far-field HRTFs based on the anthropometric features corresponding to the user.

Aspect 7. The apparatus of any of Aspects 1 to 6, wherein the one or more candidate far-field HRTFs are selected from a plurality of far-field HRTFs based on pinna-shape matching using image data of ears of the user.

Aspect 8. The apparatus of Aspect 7, wherein the image data is obtained using a camera of a handheld user computing device, and wherein the plurality of audio measurements are obtained based on a plurality of audio tones outputted using a speaker of the handheld user computing device.

Aspect 9. The apparatus of any of Aspects 1 to 8, wherein the one or more candidate far-field HRTFs are obtained as a selection from a plurality of reference far-field HRTFs, and wherein the selection is performed based on anthropometric features corresponding to image data of ears of the user.

Aspect 10. The apparatus of any of Aspects 1 to 9, wherein the one or more processors are configured to determine the individualized HRTF for the user based on using the set of far-field HRTFs corresponding to the user as a selection criteria to refine a plurality of candidate far-field HRTFs associated with the anthropometric features.

Aspect 11. The apparatus of any of Aspects 1 to 10, wherein the plurality of audio measurements are mobile-to-ear audio measurements.

Aspect 12. The apparatus of any of Aspects 1 to 11, wherein the plurality of audio measurements are obtained using a handheld device associated with the user and a pair of ear-worn devices associated with the user.

Aspect 13. The apparatus of any of Aspects 1 to 12, wherein the respective measurement position associated with each audio measurement of the plurality of audio measurements is indicative of a relative position or orientation between the user and a handheld device associated with the user.

Aspect 14. The apparatus of any of Aspects 1 to 13, wherein the respective measurement position associated with each audio measurement of the plurality of audio measurements is indicative of a relative position or orientation between a pair of ear-worn devices associated with the user and a handheld device associated with the user.

Aspect 15. The apparatus of any of Aspects 1 to 14, wherein each audio measurement of the plurality of audio measurements is a recording of an audio tone outputted from a speaker at the respective measurement position, and wherein the recording of the audio tone is obtained from a microphone included in an ear-worn device of the user.

Aspect 16. The apparatus of Aspect 15, wherein the near-field measurement distance corresponds to a distance between the ear-worn device of the user and the speaker at the respective measurement position.

Aspect 17. The apparatus of any of Aspects 1 to 16, wherein: the respective measurement position is indicative of an azimuth and an elevation between an audio source and a microphone; and each audio measurement of the plurality of audio measurements corresponds to an audio tone played by the audio source and recorded by the microphone.

Aspect 18. The apparatus of any of Aspects 1 to 17, wherein, to generate the set of far-field HRTFs, the one or more processors are configured to: extrapolate the set of near-field HRTFs from a near-field measurement distance of the respective measurement position to a configured far-field measurement distance, wherein the configured far-field measurement distance is greater than the near-field measurement distance.

Aspect 19. The apparatus of Aspect 18, wherein the configured far-field measurement distance is associated with the one or more candidate far-field HRTFs.

Aspect 20. The apparatus of any of Aspects 18 to 19, wherein the configured far-field measurement distance is associated with an HRTF database including a plurality of far-field HRTFs.

Aspect 21. The apparatus of Aspect 20, wherein the plurality of far-field HRTFs includes the one or more candidate far-field HRTFs.

Aspect 22. The apparatus of any of Aspects 1 to 21, wherein, to generate the set of far-field HRTFs, the one or more processors are configured to: determine one or more distance-based characteristics corresponding to the set of near-field HRTFs; and extrapolate the one or more distance-based characteristics from a near-field measurement distance to a configured far-field measurement distance, to thereby generate a set of extrapolated far-field HRTFs corresponding to the user and the configured far-field measurement distance.

Aspect 23. The apparatus of any of Aspects 1 to 22, wherein the set of far-field HRTFs includes a plurality of extrapolated far-field HRTFs, and wherein each extrapolated far-field HRTF of the plurality of extrapolated far-field HRTFs corresponds to: a respective near-field HRTF included in the set of near-field HRTFs; and a configured far-field measurement distance greater than a near-field measurement distance associated with the respective near-field HRTF.

Aspect 24. The apparatus of Aspect 23, wherein: the set of near-field HRTFs is associated with a plurality of different near-field measurement distances associated with obtaining the plurality of audio measurements; and the configured far-field measurement distance is used for each extrapolated far-field HRTF of the plurality of extrapolated far-field HRTFs.

Aspect 25. The apparatus of any of Aspects 1 to 24, wherein, to determine the set of near-field HRTFs corresponding to the user, the one or more processors are configured to: output, from a speaker included in a handheld computing device associated with the user, a sweep signal at each respective measurement position of a plurality of discrete measurement positions configured for the plurality of audio measurements; and obtain, from a left ear-worn device and a right ear-worn device of the user, a corresponding mobile-to-ear audio measurement of the sweep signal at the respective measurement position.

Aspect 26. The apparatus of Aspect 25, wherein the near-field measurement distance comprises a distance between the handheld computing device and one or more of the left ear-worn device or the right ear-worn device of the user.

Aspect 27. The apparatus of any of Aspects 25 to 26, wherein the one or more processors are configured to: perform noise suppression or noise cancellation for the corresponding mobile-to-ear audio measurement, to thereby obtain an audio measurement of the plurality of audio measurements.

Aspect 28. A method for processing audio data, comprising: determining, based on a plurality of audio measurements associated with a near-field measurement distance, a set of near-field Head-Related Transfer Functions (HRTFs) corresponding to a user, wherein each audio measurement of the plurality of audio measurements is obtained using a respective measurement position; generating a set of far-field HRTFs corresponding to the user, wherein the set of far-field HRTFs is based on the set of near-field HRTFs; comparing the set of far-field HRTFs to one or more candidate far-field HRTFs, wherein the one or more candidate far-field HRTFs are obtained based on anthropometric features corresponding to the user; and determining an individualized HRTF for the user as a candidate far-field HRTF of the one or more candidate far-field HRTFs having minimum spectral differences from the set of far-field HRTFs at corresponding measurement positions.

Aspect 29. The method of Aspect 28, wherein: the set of near-field HRTFs includes a respective near-field HRTF corresponding to each measurement orientation of a plurality of measurement orientations; and the set of far-field HRTFs are generated to include a respective far-field HRTF corresponding to each measurement orientation of the plurality of measurement orientations.

Aspect 30. The method of Aspect 29, wherein each candidate far-field HRTF of the one or more candidate far-field HRTFs comprises an HRTF subset corresponding to the plurality of measurement orientations and a configured far-field matching distance.

Aspect 31. The method of any of Aspects 29 to 30, wherein comparing the set of far-field HRTFs to the one or more candidate far-field HRTFs includes: for each measurement orientation of the plurality of measurement orientations, comparing the respective far-field HRTF corresponding to the measurement orientation and a subset of the one or more candidate far-field HRTFs corresponding to the measurement orientation.

Aspect 32. The method of any of Aspects 30 to 31, wherein the set of far-field HRTFs is generated using a configured far-field distance associated with the one or more candidate far-field HRTFs.

Aspect 33. The method of any of Aspects 28 to 32, wherein the one or more candidate far-field HRTFs are selected from a plurality of far-field HRTFs based on the anthropometric features corresponding to the user.

Aspect 34. The method of any of Aspects 28 to 33, wherein the one or more candidate far-field HRTFs are selected from a plurality of far-field HRTFs based on pinna-shape matching using image data of ears of the user.

Aspect 35. The method of Aspect 34, wherein the image data is obtained using a camera of a handheld user computing device, and wherein the plurality of audio measurements are obtained based on a plurality of audio tones outputted using a speaker of the handheld user computing device.

Aspect 36. The method of any of Aspects 28 to 35, wherein the one or more candidate far-field HRTFs are obtained as a selection from a plurality of reference far-field HRTFs, and wherein the selection is performed based on anthropometric features corresponding to image data of ears of the user.

Aspect 37. The method of any of Aspects 28 to 36, further comprising determining the individualized HRTF for the user based on using the set of far-field HRTFs corresponding to the user as a selection criteria to refine a plurality of candidate far-field HRTFs associated with the anthropometric features.

Aspect 38. The method of any of Aspects 28 to 37, wherein the plurality of audio measurements are mobile-to-ear audio measurements.

Aspect 39. The method of any of Aspects 28 to 38, wherein the plurality of audio measurements are obtained using a handheld device associated with the user and a pair of ear-worn devices associated with the user.

Aspect 40. The method of any of Aspects 28 to 39, wherein the respective measurement position associated with each audio measurement of the plurality of audio measurements is indicative of a relative position or orientation between the user and a handheld device associated with the user.

Aspect 41. The method of any of Aspects 28 to 40, wherein the respective measurement position associated with each audio measurement of the plurality of audio measurements is indicative of a relative position or orientation between a pair of ear-worn devices associated with the user and a handheld device associated with the user.

Aspect 42. The method of any of Aspects 28 to 41, wherein each audio measurement of the plurality of audio measurements is a recording of an audio tone outputted from a speaker at the respective measurement position, and wherein the recording of the audio tone is obtained from a microphone included in an ear-worn device of the user.

Aspect 43. The method of Aspect 42, wherein the near-field measurement distance corresponds to a distance between the ear-worn device of the user and the speaker at the respective measurement position.

Aspect 44. The method of any of Aspects 28 to 43, wherein: the respective measurement position is indicative of an azimuth and an elevation between an audio source and a microphone; and each audio measurement of the plurality of audio measurements corresponds to an audio tone played by the audio source and recorded by the microphone.

Aspect 45. The method of any of Aspects 28 to 44, wherein generating the set of far-field HRTFs includes: extrapolating the set of near-field HRTFs from a near-field measurement distance of the respective measurement position to a configured far-field measurement distance, wherein the configured far-field measurement distance is greater than the near-field measurement distance.

Aspect 46. The method of Aspect 45, wherein the configured far-field measurement distance is associated with the one or more candidate far-field HRTFs.

Aspect 47. The method of any of Aspects 45 to 46, wherein the configured far-field measurement distance is associated with an HRTF database including a plurality of far-field HRTFs.

Aspect 48. The method of Aspect 47, wherein the plurality of far-field HRTFs includes the one or more candidate far-field HRTFs.

Aspect 49. The method of any of Aspects 28 to 48, wherein generating the set of far-field HRTFs includes: determining one or more distance-based characteristics corresponding to the set of near-field HRTFs; and extrapolating the one or more distance-based characteristics from a near-field measurement distance to a configured far-field measurement distance, to thereby generate a set of extrapolated far-field HRTFs corresponding to the user and the configured far-field measurement distance.

Aspect 50. The method of any of Aspects 28 to 49, wherein the set of far-field HRTFs includes a plurality of extrapolated far-field HRTFs, and wherein each extrapolated far-field HRTF of the plurality of extrapolated far-field HRTFs corresponds to: a respective near-field HRTF included in the set of near-field HRTFs; and a configured far-field measurement distance greater than a near-field measurement distance associated with the respective near-field HRTF.

Aspect 51. The method of Aspect 50, wherein: the set of near-field HRTFs is associated with a plurality of different near-field measurement distances associated with obtaining the plurality of audio measurements; and the configured far-field measurement distance is used for each extrapolated far-field HRTF of the plurality of extrapolated far-field HRTFs.

Aspect 52. The method of any of Aspects 28 to 51, wherein determining the set of near-field HRTFs corresponding to the user includes: outputting, from a speaker included in a handheld computing device associated with the user, a sweep signal at each respective measurement position of a plurality of discrete measurement positions configured for the plurality of audio measurements; and obtaining, from a left ear-worn device and a right ear-worn device of the user, a corresponding mobile-to-ear audio measurement of the sweep signal at the respective measurement position.

Aspect 53. The method of Aspect 52, wherein the near-field measurement distance comprises a distance between the handheld computing device and one or more of the left ear-worn device or the right ear-worn device of the user.

Aspect 54. The method of any of Aspects 52 to 53, further comprising: performing noise suppression or noise cancellation for the corresponding mobile-to-ear audio measurement, to thereby obtain an audio measurement of the plurality of audio measurements.

Aspect 55. A non-transitory computer-readable storage medium comprising instructions stored thereon which, when executed by one or more processors, causes the one or more processors to perform operations according to any of Aspects 1 to 27.

Aspect 56. A non-transitory computer-readable storage medium comprising instructions stored thereon which, when executed by one or more processors, causes the one or more processors to perform operations according to any of Aspects 28 to 54.

Aspect 57. An apparatus comprising one or more means for performing operations according to any of Aspects 1 to 27.

Aspect 58. An apparatus comprising one or more means for performing operations according to any of Aspects 28 to 54.

Aspect 59. An apparatus for processing audio data, comprising: at least one memory; and one or more processors coupled to the at least one memory, the one or more processors being configured to: determine, using a plurality of audio measurements associated with a near-field measurement distance, a set of near-field Head-Related Transfer Functions (HRTFs) corresponding to a user, wherein each audio measurement of the plurality of audio measurements is obtained using a respective measurement position; generate a set of far-field HRTFs at a configured far-field measurement distance and corresponding to the user based on the set of near-field HRTFs; compare the set of far-field HRTFs to one or more candidate far-field HRTF sets, wherein the one or more candidate far-field HRTF sets are obtained based on anthropometric features corresponding to the user; and determine an individualized HRTF set for the user based on a candidate far-field HRTF set of the one or more candidate far-field HRTF sets having minimum spectral differences from the set of far-field HRTFs.

Aspect 60. The apparatus of Aspect 59, wherein: the set of near-field HRTFs includes a respective near-field HRTF corresponding to each measurement orientation of a plurality of measurement orientations at the near-field measurement distance; and the set of far-field HRTFs are generated to include a respective far-field HRTF corresponding to each measurement orientation of the plurality of measurement orientations at the configured far-field measurement distance.

Aspect 61. The apparatus of any of Aspects 59 to 60, wherein each candidate far-field HRTF set of the one or more candidate far-field HRTF sets comprises an HRTF subset corresponding to the plurality of measurement orientations and the configured far-field measurement distance.

Aspect 62. The apparatus of any of Aspects 59 to 61, wherein, to compare the set of far-field HRTFs to the one or more candidate far-field HRTF sets, the one or more processors are configured to: for each measurement orientation of the plurality of measurement orientations, compare the respective far-field HRTF corresponding to the measurement orientation with a respective candidate far-field HRTF included within each candidate far-field HRTF set of the one or more candidate far-field HRTF sets and corresponding to the measurement orientation.

Aspect 63. The apparatus of any of Aspects 59 to 62, wherein the one or more candidate far-field HRTF sets are selected from a plurality of predetermined far-field HRTF sets or an HRTF database based on the anthropometric features corresponding to the user.

Aspect 64. The apparatus of Aspect 63, wherein the anthropometric features are determined based on image data of ears of the user or three-dimensional (3D) scan data of a head of the user.

Aspect 65. The apparatus of Aspect 64, wherein the one or more candidate far-field HRTF sets are selected from the plurality of predetermined far-field HRTF sets or the HRTF database based on pinna-shape matching using the image data of the ears of the user.

Aspect 66. The apparatus of any of Aspects 64 to 65, wherein the image data or the 3D scan data is obtained using a camera of a handheld user computing device, and wherein the plurality of audio measurements are obtained based on a plurality of audio tones outputted using a speaker of the handheld user computing device.

Aspect 67. The apparatus of any of Aspects 59 to 66, wherein the one or more processors are configured to determine the individualized HRTF set for the user based on using the set of far-field HRTFs corresponding to the user as a selection criteria to refine a plurality of candidate far-field HRTF sets associated with the anthropometric features.

Aspect 68. The apparatus of any of Aspects 59 to 67, wherein the plurality of audio measurements are mobile-to-ear audio measurements of audio from a mobile computing device to ears of the user.

Aspect 69. The apparatus of any of Aspects 59 to 68, wherein the plurality of audio measurements are obtained using a handheld device associated with the user and a pair of ear-worn devices associated with the user.

Aspect 70. The apparatus of any of Aspects 59 to 69, wherein the respective measurement position associated with each audio measurement of the plurality of audio measurements is indicative of a relative position or orientation between the user and a handheld device associated with the user.

Aspect 71. The apparatus of Aspect 70, wherein the relative position or orientation between the user and the handheld device associated with the user is obtained by analyzing image data captured by the handheld device.

Aspect 72. The apparatus of any of Aspects 59 to 71, wherein the respective measurement position associated with each audio measurement of the plurality of audio measurements is indicative of a relative position or orientation between a pair of ear-worn devices associated with the user and a handheld device associated with the user.

Aspect 73. The apparatus of Aspect 72, wherein the relative position or orientation between the pair of ear-worn devices and the handheld device is obtained by: analyzing image data captured by the handheld device to determine a relative position or orientation between the user and the handheld device; and determining the relative position or orientation between the pair of ear-worn devices and the handheld device based on the relative position or orientation between the user and the handheld device.

Aspect 74. The apparatus of any of Aspects 59 to 73, wherein each audio measurement of the plurality of audio measurements is a recording of an audio tone outputted from a speaker at the respective measurement position, and wherein the recording of the audio tone is obtained from a microphone included in an ear-worn device of the user.

Aspect 75. The apparatus of Aspect 74, wherein the near-field measurement distance corresponds to a distance between the ear-worn device of the user and the speaker at the respective measurement position.

Aspect 76. The apparatus of any of Aspects 59 to 75, wherein: the respective measurement position for each audio measurement of the plurality of audio measurements includes a distance less than or equal to the near-field measurement distance and includes a measurement orientation indicative of an azimuth and an elevation between an audio source and a microphone; and each audio measurement of the plurality of audio measurements corresponds to an audio tone played by the audio source and recorded by the microphone.

Aspect 77. The apparatus of any of Aspects 59 to 76, wherein, to generate the set of far-field HRTFs, the one or more processors are configured to: perform extrapolation using a near-field HRTF of the set of near-field HRTFs at a respective measurement orientation and the near-field measurement distance, to obtain a far-field HRTF of the set of far-field HRTFs at the respective measurement orientation and the configured far-field measurement distance, wherein the configured far-field measurement distance is greater than the near-field measurement distance.

Aspect 78. The apparatus of any of Aspects 59 to 77, wherein, to generate the set of far-field HRTFs, the one or more processors are configured to: determine one or more distance-based characteristics corresponding to the set of near-field HRTFs; and extrapolate the one or more distance-based characteristics from a near-field measurement distance to a configured far-field measurement distance, to thereby generate a set of extrapolated far-field HRTFs corresponding to the user and the configured far-field measurement distance.

Aspect 79. The apparatus of any of Aspects 59 to 78, wherein the set of far-field HRTFs includes a plurality of extrapolated far-field HRTFs, and wherein each extrapolated far-field HRTF of the plurality of extrapolated far-field HRTFs corresponds to: a respective near-field HRTF included in the set of near-field HRTFs; and a configured far-field measurement distance greater than a near-field measurement distance associated with the respective near-field HRTF.

Aspect 80. The apparatus of Aspect 79, wherein: the set of near-field HRTFs is associated with a plurality of different near-field measurement distances associated with obtaining the plurality of audio measurements; and the configured far-field measurement distance is used for each extrapolated far-field HRTF of the plurality of extrapolated far-field HRTFs.

Aspect 81. The apparatus of any of Aspects 59 to 80, wherein, to determine the set of near-field HRTFs corresponding to the user, the one or more processors are configured to: output, from a speaker included in a handheld computing device associated with the user, a sweep signal at each respective measurement position of a plurality of discrete measurement positions configured for the plurality of audio measurements; obtain, from a left ear-worn device and a right ear-worn device of the user, a corresponding mobile-to-ear audio measurement of the sweep signal at the respective measurement position; and determine a near-field HRTF of the set of near-field HRTFs at the respective measurement position based on the mobile-to-ear audio measurement.

Aspect 82. The apparatus of Aspect 81, wherein the near-field measurement distance comprises a distance between the handheld computing device and one or more of the left ear-worn device or the right ear-worn device of the user.

Aspect 83. The apparatus of any of Aspects 81 to 82, wherein the one or more processors are configured to: perform noise suppression or noise cancellation for the corresponding mobile-to-ear audio measurement, to thereby obtain an audio measurement of the plurality of audio measurements.

Aspect 84. A method for processing audio data, comprising: determining, using a plurality of audio measurements associated with a near-field measurement distance, a set of near-field Head-Related Transfer Functions (HRTFs) corresponding to a user, wherein each audio measurement of the plurality of audio measurements is obtained using a respective measurement position; generating a set of far-field HRTFs at a configured far-field measurement distance and corresponding to the user based on the set of near-field HRTFs; comparing the set of far-field HRTFs to one or more candidate far-field HRTF sets, wherein the one or more candidate far-field HRTF sets are obtained based on anthropometric features corresponding to the user; and determining an individualized HRTF set for the user based on a candidate far-field HRTF set of the one or more candidate far-field HRTF sets having minimum spectral differences from the set of far-field HRTFs.

Aspect 85. The method of Aspect 84, wherein: the set of near-field HRTFs includes a respective near-field HRTF corresponding to each measurement orientation of the plurality of measurement orientations at the near-field measurement distance; and the set of far-field HRTFs are generated to include a respective far-field HRTF corresponding to each measurement orientation of the plurality of measurement orientations at the configured far-field measurement distance.

Aspect 86. The method of Aspect 85, wherein: each candidate far-field HRTF set of the one or more candidate far-field HRTF sets comprises an HRTF subset corresponding to the plurality of measurement orientations and the configured far-field measurement distance; and comparing the set of far-field HRTFs to the one or more candidate far-field HRTF sets includes: determining one or more candidate far-field HRTF subsets corresponding to the plurality of measurement orientations and the configured far-field measurement distance from the one or more candidate far-field HRTF sets; and comparing the set of far-field HRTFs to the one or more candidate far-field HRTF subsets.

Aspect 87. The method of any of Aspects 84 to 86, wherein determining the individualized HRTF set for the user is based on: using the set of far-field HRTFs corresponding to the user as a selection criteria to refine a plurality of candidate far-field HRTF sets associated with the anthropometric features.

Aspect 88. The method of any of Aspects 84 to 87, wherein the anthropometric features are determined based on image data of ears of the user or three-dimensional (3D) scan data of a head of the user, and wherein the one or more candidate far-field HRTF sets are selected from a plurality of predetermined far-field HRTF sets or an HRTF reference database based on pinna-shape matching using the image data of the ears of the user or the 3D scan data of the head of the user.

Aspect 89. The method of any of Aspects 84 to 88, wherein: the set of near-field HRTFs includes a respective near-field HRTF corresponding to each measurement orientation of a plurality of measurement orientations at the near-field measurement distance; and the set of far-field HRTFs are generated to include a respective far-field HRTF corresponding to each measurement orientation of the plurality of measurement orientations at the configured far-field measurement distance.

Aspect 90. The method of any of Aspects 84 to 89, wherein each candidate far-field HRTF set of the one or more candidate far-field HRTF sets comprises an HRTF subset corresponding to the plurality of measurement orientations and the configured far-field measurement distance.

Aspect 91. The method of any of Aspects 84 to 90, wherein comparing the set of far-field HRTFs to the one or more candidate far-field HRTF sets includes: for each measurement orientation of the plurality of measurement orientations, comparing the respective far-field HRTF corresponding to the measurement orientation with a respective candidate far-field HRTF included within each candidate far-field HRTF set of the one or more candidate far-field HRTF sets and corresponding to the measurement orientation.

Aspect 92. The method of any of Aspects 84 to 91, wherein the one or more candidate far-field HRTF sets are selected from a plurality of predetermined far-field HRTF sets or an HRTF database based on the anthropometric features corresponding to the user.

Aspect 93. The method of Aspect 92, wherein the anthropometric features are determined based on image data of ears of the user or three-dimensional (3D) scan data of a head of the user.

Aspect 94. The method of Aspect 93, wherein the one or more candidate far-field HRTF sets are selected from the plurality of predetermined far-field HRTF sets or the HRTF database based on pinna-shape matching using the image data of the ears of the user.

Aspect 95. The method of any of Aspects 93 to 94, wherein the image data or the 3D scan data is obtained using a camera of a handheld user computing device, and wherein the plurality of audio measurements are obtained based on a plurality of audio tones outputted using a speaker of the handheld user computing device.

Aspect 96. The method of any of Aspects 84 to 95, further comprising determining the individualized HRTF set for the user based on using the set of far-field HRTFs corresponding to the user as a selection criteria to refine a plurality of candidate far-field HRTF sets associated with the anthropometric features.

Aspect 97. The method of any of Aspects 84 to 96, wherein the plurality of audio measurements are mobile-to-ear audio measurements of audio from a mobile computing device to ears of the user.

Aspect 98. The method of any of Aspects 84 to 97, wherein the plurality of audio measurements are obtained using a handheld device associated with the user and a pair of ear-worn devices associated with the user.

Aspect 99. The method of any of Aspects 84 to 98, wherein the respective measurement position associated with each audio measurement of the plurality of audio measurements is indicative of a relative position or orientation between the user and a handheld device associated with the user.

Aspect 100. The method of Aspect 99, wherein the relative position or orientation between the user and the handheld device associated with the user is obtained by analyzing image data captured by the handheld device.

Aspect 101. The method of any of Aspects 84 to 100, wherein the respective measurement position associated with each audio measurement of the plurality of audio measurements is indicative of a relative position or orientation between a pair of ear-worn devices associated with the user and a handheld device associated with the user.

Aspect 102. The method of Aspect 101, wherein the relative position or orientation between the pair of ear-worn devices and the handheld device is obtained by: analyzing image data captured by the handheld device to determine a relative position or orientation between the user and the handheld device; and determining the relative position or orientation between the pair of ear-worn devices and the handheld device based on the relative position or orientation between the user and the handheld device.

Aspect 103. The method of any of Aspects 84 to 102, wherein each audio measurement of the plurality of audio measurements is a recording of an audio tone outputted from a speaker at the respective measurement position, and wherein the recording of the audio tone is obtained from a microphone included in an ear-worn device of the user.

Aspect 104. The method of Aspect 103, wherein the near-field measurement distance corresponds to a distance between the ear-worn device of the user and the speaker at the respective measurement position.

Aspect 105. The method of any of Aspects 84 to 104, wherein: the respective measurement position for each audio measurement of the plurality of audio measurements includes a distance less than or equal to the near-field measurement distance and includes a measurement orientation indicative of an azimuth and an elevation between an audio source and a microphone; and each audio measurement of the plurality of audio measurements corresponds to an audio tone played by the audio source and recorded by the microphone.

Aspect 106. The method of any of Aspects 84 to 105, wherein generating the set of far-field HRTFs includes: performing extrapolation using a near-field HRTF of the set of near-field HRTFs at a respective measurement orientation and the near-field measurement distance, to obtain a far-field HRTF of the set of far-field HRTFs at the respective measurement orientation and the configured far-field measurement distance, wherein the configured far-field measurement distance is greater than the near-field measurement distance.

Aspect 107. The method of any of Aspects 84 to 106, wherein generating the set of far-field HRTFs includes: determining one or more distance-based characteristics corresponding to the set of near-field HRTFs; and extrapolating the one or more distance-based characteristics from a near-field measurement distance to a configured far-field measurement distance, to thereby generate a set of extrapolated far-field HRTFs corresponding to the user and the configured far-field measurement distance.

Aspect 108. The method of any of Aspects 84 to 107, wherein the set of far-field HRTFs includes a plurality of extrapolated far-field HRTFs, and wherein each extrapolated far-field HRTF of the plurality of extrapolated far-field HRTFs corresponds to: a respective near-field HRTF included in the set of near-field HRTFs; and a configured far-field measurement distance greater than a near-field measurement distance associated with the respective near-field HRTF.

Aspect 109. The method of Aspect 108, wherein: the set of near-field HRTFs is associated with a plurality of different near-field measurement distances associated with obtaining the plurality of audio measurements; and the configured far-field measurement distance is used for each extrapolated far-field HRTF of the plurality of extrapolated far-field HRTFs.

Aspect 110. The method of any of Aspects 84 to 109, wherein determining the set of near-field HRTFs corresponding to the user includes: outputting, from a speaker included in a handheld computing device associated with the user, a sweep signal at each respective measurement position of a plurality of discrete measurement positions configured for the plurality of audio measurements; obtaining, from a left ear-worn device and a right ear-worn device of the user, a corresponding mobile-to-ear audio measurement of the sweep signal at the respective measurement position; and determining a near-field HRTF of the set of near-field HRTFs at the respective measurement position based on the mobile-to-ear audio measurement.

Aspect 111. The method of Aspect 110, wherein the near-field measurement distance comprises a distance between the handheld computing device and one or more of the left ear-worn device or the right ear-worn device of the user.

Aspect 112. The method of any of Aspects 110 to 111, wherein the one or more processors are configured to: perform noise suppression or noise cancellation for the corresponding mobile-to-ear audio measurement, to thereby obtain an audio measurement of the plurality of audio measurements.

Aspect 113. A non-transitory computer-readable storage medium comprising instructions stored thereon which, when executed by one or more processors, causes the one or more processors to perform operations according to any of Aspects 59 to 83.

Aspect 114. A non-transitory computer-readable storage medium comprising instructions stored thereon which, when executed by one or more processors, causes the one or more processors to perform operations according to any of Aspects 84 to 112.

Aspect 115. An apparatus comprising one or more means for performing operations according to any of Aspects 59 to 83.

Aspect 116. An apparatus comprising one or more means for performing operations according to any of Aspects 84 to 112.

What is claimed is:

1. An apparatus for processing audio data, comprising:
one or more memories; and
one or more processors coupled to the one or more memories, the one or more processors being configured to:
determine, using a plurality of audio measurements associated with a near-field measurement distance, a set of near-field Head-Related Transfer Functions (HRTFs) corresponding to a user, wherein each audio measurement of the plurality of audio measurements is obtained using a respective measurement position;
generate a set of far-field HRTFs at a configured far-field measurement distance and corresponding to the user based on the set of near-field HRTFs;
compare the set of far-field HRTFs to one or more candidate far-field HRTF sets, wherein the one or more candidate far-field HRTF sets are obtained based on anthropometric features corresponding to the user; and
determine an individualized HRTF set for the user based on a candidate far-field HRTF set of the one or more candidate far-field HRTF sets having minimum spectral differences from the set of far-field HRTFs.

2. The apparatus of claim 1, wherein:
the set of near-field HRTFs includes a respective near-field HRTF corresponding to each measurement orientation of a plurality of measurement orientations at the near-field measurement distance; and
the set of far-field HRTFs are generated to include a respective far-field HRTF corresponding to each measurement orientation of the plurality of measurement orientations at the configured far-field measurement distance.

3. The apparatus of claim 2, wherein each candidate far-field HRTF set of the one or more candidate far-field HRTF sets comprises an HRTF subset corresponding to the plurality of measurement orientations and the configured far-field measurement distance.

4. The apparatus of claim 2, wherein, to compare the set of far-field HRTFs to the one or more candidate far-field HRTF sets, the one or more processors are configured to:
for each measurement orientation of the plurality of measurement orientations, compare the respective far-field HRTF corresponding to the measurement orientation with a respective candidate far-field HRTF included within each candidate far-field HRTF set of the one or more candidate far-field HRTF sets and corresponding to the measurement orientation.

5. The apparatus of claim 1, wherein the one or more candidate far-field HRTF sets are selected from a plurality of predetermined far-field HRTF sets or an HRTF database based on the anthropometric features corresponding to the user.

6. The apparatus of claim 5, wherein the anthropometric features are determined based on image data of ears of the user or three-dimensional (3D) scan data of a head of the user.

7. The apparatus of claim 6, wherein the one or more candidate far-field HRTF sets are selected from the plurality of predetermined far-field HRTF sets or the HRTF database based on pinna-shape matching using the image data of the ears of the user.

8. The apparatus of claim 6, wherein the image data or the 3D scan data is obtained using a camera of a handheld user computing device, and wherein the plurality of audio measurements are obtained based on a plurality of audio tones outputted using a speaker of the handheld user computing device.

9. The apparatus of claim 1, wherein the one or more processors are configured to determine the individualized HRTF set for the user based on using the set of far-field HRTFs corresponding to the user as a selection criteria to refine a plurality of candidate far-field HRTF sets associated with the anthropometric features.

10. The apparatus of claim 1, wherein the plurality of audio measurements are mobile-to-ear audio measurements of audio from a mobile computing device to ears of the user.

11. The apparatus of claim 1, wherein the plurality of audio measurements are obtained using a handheld device associated with the user and a pair of ear-worn devices associated with the user.

12. The apparatus of claim 1, wherein the respective measurement position associated with each audio measurement of the plurality of audio measurements is indicative of a relative position or orientation between the user and a handheld device associated with the user.

13. The apparatus of claim 12, wherein the relative position or orientation between the user and the handheld device associated with the user is obtained by analyzing image data captured by the handheld device.

14. The apparatus of claim 1, wherein the respective measurement position associated with each audio measurement of the plurality of audio measurements is indicative of a relative position or orientation between a pair of ear-worn devices associated with the user and a handheld device associated with the user.

15. The apparatus of claim 14, wherein the relative position or orientation between the pair of ear-worn devices and the handheld device is obtained by:
analyzing image data captured by the handheld device to determine a relative position or orientation between the user and the handheld device; and
determining the relative position or orientation between the pair of ear-worn devices and the handheld device based on the relative position or orientation between the user and the handheld device.

16. The apparatus of claim 1, wherein each audio measurement of the plurality of audio measurements is a recording of an audio tone outputted from a speaker at the respective measurement position, and wherein the recording of the audio tone is obtained from a microphone included in an ear-worn device of the user.

17. The apparatus of claim 16, wherein the near-field measurement distance corresponds to a distance between the ear-worn device of the user and the speaker at the respective measurement position.

18. The apparatus of claim 1, wherein:
the respective measurement position for each audio measurement of the plurality of audio measurements includes a distance less than or equal to the near-field measurement distance and includes a measurement orientation indicative of an azimuth and an elevation between an audio source and a microphone; and
each audio measurement of the plurality of audio measurements corresponds to an audio tone played by the audio source and recorded by the microphone.

19. The apparatus of claim 1, wherein, to generate the set of far-field HRTFs, the one or more processors are configured to:
perform extrapolation using a near-field HRTF of the set of near-field HRTFs at a respective measurement orientation and the near-field measurement distance, to obtain a far-field HRTF of the set of far-field HRTFs at the respective measurement orientation and the configured far-field measurement distance, wherein the configured far-field measurement distance is greater than the near-field measurement distance.

20. The apparatus of claim 1, wherein, to generate the set of far-field HRTFs, the one or more processors are configured to:
determine one or more distance-based characteristics corresponding to the set of near-field HRTFs; and
extrapolate the one or more distance-based characteristics from a near-field measurement distance to a configured far-field measurement distance, to thereby generate a set of extrapolated far-field HRTFs corresponding to the user and the configured far-field measurement distance.

21. The apparatus of claim 1, wherein the set of far-field HRTFs includes a plurality of extrapolated far-field HRTFs, and wherein each extrapolated far-field HRTF of the plurality of extrapolated far-field HRTFs corresponds to:
a respective near-field HRTF included in the set of near-field HRTFs; and
a configured far-field measurement distance greater than a near-field measurement distance associated with the respective near-field HRTF.

22. The apparatus of claim 21, wherein:
the set of near-field HRTFs is associated with a plurality of different near-field measurement distances associated with obtaining the plurality of audio measurements; and
the configured far-field measurement distance is used for each extrapolated far-field HRTF of the plurality of extrapolated far-field HRTFs.

23. The apparatus of claim 1, wherein, to determine the set of near-field HRTFs corresponding to the user, the one or more processors are configured to:
output, from a speaker included in a handheld computing device associated with the user, a sweep signal at each respective measurement position of a plurality of discrete measurement positions configured for the plurality of audio measurements;
obtain, from a left ear-worn device and a right ear-worn device of the user, a corresponding mobile-to-ear audio measurement of the sweep signal at the respective measurement position; and
determine a near-field HRTF of the set of near-field HRTFs at the respective measurement position based on the mobile-to-ear audio measurement.

24. The apparatus of claim 23, wherein the near-field measurement distance comprises a distance between the handheld computing device and one or more of the left ear-worn device or the right ear-worn device of the user.

25. The apparatus of claim 23, wherein the one or more processors are configured to:
perform noise suppression or noise cancellation for the corresponding mobile-to-ear audio measurement, to thereby obtain an audio measurement of the plurality of audio measurements.

26. A method for processing audio data, comprising:
determining, using a plurality of audio measurements associated with a near-field measurement distance, a set of near-field Head-Related Transfer Functions (HRTFs) corresponding to a user, wherein each audio measurement of the plurality of audio measurements is obtained using a respective measurement position;
generating a set of far-field HRTFs at a configured far-field measurement distance and corresponding to the user based on the set of near-field HRTFs;
comparing the set of far-field HRTFs to one or more candidate far-field HRTF sets, wherein the one or more candidate far-field HRTF sets are obtained based on anthropometric features corresponding to the user; and
determining an individualized HRTF set for the user based on a candidate far-field HRTF set of the one or more candidate far-field HRTF sets having minimum spectral differences from the set of far-field HRTFs.

27. The method of claim 26, wherein:
the set of near-field HRTFs includes a respective near-field HRTF corresponding to each measurement orientation of a plurality of measurement orientations at the near-field measurement distance; and
the set of far-field HRTFs are generated to include a respective far-field HRTF corresponding to each measurement orientation of the plurality of measurement orientations at the configured far-field measurement distance.

28. The method of claim 27, wherein:
each candidate far-field HRTF set of the one or more candidate far-field HRTF sets comprises an HRTF subset corresponding to a plurality of measurement orientations and the configured far-field measurement distance; and
comparing the set of far-field HRTFs to the one or more candidate far-field HRTF sets includes:
determining one or more candidate far-field HRTF subsets corresponding to the plurality of measurement orientations and the configured far-field measurement distance from the one or more candidate far-field HRTF sets; and
comparing the set of far-field HRTFs to the one or more candidate far-field HRTF subsets.

29. The method of claim 26, wherein determining the individualized HRTF set for the user is based on:
using the set of far-field HRTFs corresponding to the user as a selection criteria to refine a plurality of candidate far-field HRTF sets associated with the anthropometric features.

30. The method of claim 26, wherein the anthropometric features are determined based on image data of ears of the user or three-dimensional (3D) scan data of a head of the user, and wherein the one or more candidate far-field HRTF sets are selected from a plurality of predetermined far-field HRTF sets or an HRTF reference database based on pinna-shape matching using the image data of the ears of the user or the 3D scan data of the head of the user.
